(19) United States
(12) Patent Application Publication
(10) Pub. No.: US 2023/0058488 A1
(43) Pub. Date: Feb. 23, 2023

(54) NEGOTIATION APPARATUS, NEGOTIATION METHOD, AND NONTRANSITORY COMPUTER READABLE MEDIUM STORING PROGRAM

(71) Applicant: NEC Corporation, Minato-ku, Tokyo (JP)

(72) Inventors: Kazuma SHIMIZU, Tokyo (JP); Satoshi MORINAGA, Tokyo (JP); Shinji NAKADAI, Tokyo (JP); Tomohito ANDO, Tokyo (JP)

(73) Assignee: NEC Corporation, Minato-ku, Tokyo (JP)

(21) Appl. No.: 17/796,693

(22) PCT Filed: Feb. 10, 2020
(86) PCT No.: PCT/JP2020/005193

§ 371 Date: Aug. 1, 2022

(51) Int. Cl. G06Q 10/08; G06Q 10/06; G06Q 30/02

(52) U.S. Cl. CPC G06Q 10/08; G06Q 10/06315; G06Q 30/0206

(57) ABSTRACT

A negotiation apparatus capable of efficiently conducting appropriate negotiations is provided. A negotiation apparatus (1) includes a condition acquisition unit (2), a calculation unit (4), and an operation decision unit (6). The condition acquisition unit (2) acquires a demand condition including one or more elements regarding demand for a commodity or a service. The calculation unit (4) calculates a utility value of the acquired demand condition using a predetermined utility function based on resource information. The resource information indicates availability status of one or more resources required to provide the commodity or the like. The operation decision unit (6) decides a negotiation operation, which is an operation regarding a negotiation for providing the commodity or the like based on the calculated utility value.

### TECHNICAL FIELD

The present invention relates to a negotiation apparatus, a negotiation method, and a non-transitory computer readable medium storing a program.

### BACKGROUND ART

Techniques for conducting automatic negotiations have been known. With regard to one such technique, Patent Literature 1 discloses a delivery date adjustment assistance apparatus that calculates the delivery date of a new order from a customer based on information on a production slot, which is a manufacturing schedule plan in a manufacturing department planned in advance, and information on orders that have already been accepted. Further, Patent Literature 2 discloses a method by which a search type negotiation using a utility function can be conducted.

### CITATION LIST

### Patent Literature

[Patent Literature 1] Japanese Unexamined Patent Application Publication No. 2008-165723
[Patent Literature 2] Japanese Unexamined Patent Application Publication No. 2005-352702

### SUMMARY OF INVENTION

### Technical Problem

When a commodity or a service is supplied, it is required not only to provide the commodity or the service in such a way that demand is satisfied but also to cause the benefit for the organization, which corresponds to a supplier, to be increased based on conditions composed of elements such as the delivery date, the expense, the quantity and the like of the commodity or the service. However, according to the techniques disclosed in the aforementioned Patent Literature, it is possible that negotiations that are appropriate for the organization may not be efficiently conducted.

The present disclosure has been made in order to solve the aforementioned problem and an object of the present disclosure is to provide a negotiation apparatus, a negotiation method, and a program capable of efficiently conducting appropriate negotiations.

### Solution to Problem

A negotiation apparatus according to the present disclosure includes: condition acquisition means for acquiring a demand condition including one or more elements regarding demand for a commodity or a service; calculation means for calculating a utility value of the acquired demand condition using a predetermined utility function based on resource information indicating an availability status of one or more resources required to provide the commodity or the service; and operation decision means for deciding a negotiation operation, which is an operation regarding a negotiation for providing the commodity or the service, based on the calculated utility value.

Further, a negotiation method according to the present disclosure includes: acquiring a demand condition including one or more elements regarding demand for a commodity or a service; calculating a utility value of the acquired demand condition using a predetermined utility function based on resource information indicating an availability status of one or more resources required to provide the commodity or the service; and deciding a negotiation operation, which is an operation regarding a negotiation for providing the commodity or the service, based on the calculated utility value.

Further, a program according to the present disclosure causes a computer to execute the following steps of: acquiring a demand condition including one or more elements regarding demand for a commodity or a service; calculating a utility value of the acquired demand condition using a predetermined utility function based on resource information indicating an availability status of one or more resources required to provide the commodity or the service; and deciding a negotiation operation, which is an operation regarding a negotiation for providing the commodity or the service, based on the calculated utility value.

### Advantageous Effects of Invention

According to the present disclosure, it is possible to provide a negotiation apparatus, a negotiation method, and a program capable of efficiently conducting appropriate negotiations.

### BRIEF DESCRIPTION OF DRAWINGS

FIG. 1 is a diagram showing an outline of a negotiation apparatus according to an example embodiment of the present disclosure;

FIG. 2 is a diagram showing a configuration of a negotiation system according to a first example embodiment;

FIG. 3 is a diagram showing a configuration of a negotiation apparatus according to the first example embodiment;

FIG. 4 is a diagram illustrating resource information according to the first example embodiment;

FIG. 5 is a flowchart showing a negotiation method executed by the negotiation apparatus according to the first example embodiment;

FIG. 6 is a flowchart showing details of processing of S110 shown in FIG. 5;

FIG. 7 is a diagram illustrating a reservation pattern generated in processing of S111 shown in FIG. 6;

FIG. 8 is a diagram illustrating a reservation pattern generated in the processing of S111 shown in FIG. 6;

FIG. 9 is a diagram illustrating a reservation pattern generated in the processing of S111 shown in FIG. 6;

FIG. 10 is a flowchart showing details of reallocation processing (S130) shown in FIG. 5;

FIG. 11 is a diagram for describing a reallocation method according to the first example embodiment;

FIG. 12 is a flowchart showing details of processing of S140 shown in FIG. 5;

FIG. 13 is a flowchart showing details of slot number change processing (S150) shown in FIG. 5;

FIG. 14 is a diagram for describing a method for changing the number of slots according to the first example embodiment;

FIG. 15 is a diagram for describing the method for changing the number of slots according to the first example embodiment;

FIG. 16 is a diagram for describing negotiation operations for increasing the number of slots according to the first example embodiment;

FIG. 17 is a flowchart showing details of negotiation operation execution processing (S170) shown in FIG. 5;

FIG. 18 is a flowchart showing details of the negotiation operation execution processing (S170) shown in FIG. 5;

FIG. 19 is a flowchart showing details of processing of S180 shown in FIG. 5;

FIG. 20 is a flowchart showing details of counterproposal generation processing (S190) shown in FIG. 5;

FIG. 21 is a diagram illustrating resource information that cannot meet the delivery date in arrived business deal conditions;

FIG. 22 is a diagram for describing a specific example of processing by the negotiation apparatus according to the first example embodiment;

FIG. 23 is a diagram for describing a specific example of processing by the negotiation apparatus according to the first example embodiment; and

FIG. 24 is a flowchart showing a negotiation method executed by a negotiation apparatus according to a second example embodiment.

### EXAMPLE EMBODIMENT

### (Outline of Example Embodiments According to the Present Disclosure)

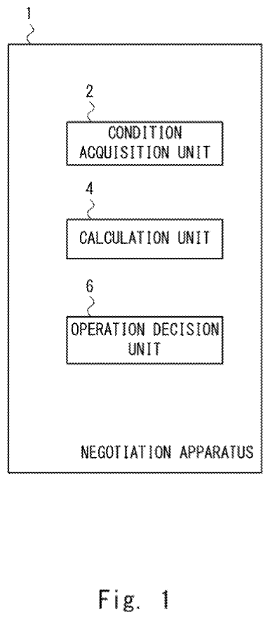

Prior to giving the description of example embodiments of the present disclosure, an outline of the example embodiments according to the present disclosure will be described. FIG. 1 is a diagram showing an outline of a negotiation apparatus 1 according to an example embodiment of the present disclosure.

The negotiation apparatus 1 is, for example, a computer. The negotiation apparatus 1 includes a condition acquisition unit 2, a calculation unit 4, and an operation decision unit 6. The condition acquisition unit 2, the calculation unit 4, and the operation decision unit 6 include functions as condition acquisition means, calculation means, and operation decision means, respectively.

The condition acquisition unit 2 acquires demand conditions including one or more elements regarding demand for a commodity or a service (hereinafter it will be referred to as a commodity or the like). The elements included in the demand conditions may be, for example, but not limited to, the delivery date, the expense, the quantity and the like of a commodity or the like. Further, the demand conditions may include, for example, but not limited to, business deal conditions regarding a business deal from a customer that has been actually arrived and demand forecast conditions regarding demand forecast. The calculation unit 4 calculates, based on resource information, a utility value of the acquired demand conditions using a predetermined utility function. The resource information indicates an availability status of one or more resources required to provide a commodity or the like. The resource information may include, for example, but not limited to, at least one of Available To Promise (ATP) and Capable to Promise (CTP). Further, the availability status may include slots capable of using the respective resources. The ATP means the attributes of each slot where the delivery date can be immediately answered. Further, the CTP means attributes of each slot where there is room for negotiation on the response on the delivery date.

The operation decision unit 6 decides, based on the calculated utility value, a negotiation operation, which is an operation regarding negotiations for providing a commodity or the like. The negotiation operation may include, for example, but not limited to, an operation of accepting business deal conditions, rejecting the business deal conditions, and securing new slots for supplying resources.

The aforementioned technique disclosed in Patent Literature 1 merely discloses accepting an order if a product can be produced to meet a customer's desired delivery date, taking into account a remaining production slot or the like. Therefore, according to the technique disclosed in Patent Literature 1, it is possible that new orders cannot be assigned in such a manner that the benefit for the organization is improved. Further, the aforementioned Patent Literature 2 only discloses a technique for conducting negotiations using a utility function for evaluating utility of transaction condition proposal using a proposal creating rule group. Therefore, according to the technique disclosed in Patent Literature 2, it is possible that negotiations may not be conducted in view of the actual availability status of resources of the organization, which corresponds to the supplier. Therefore, in the technique disclosed in the aforementioned Patent Literature, it is possible that negotiations that are appropriate for organizations may not be efficiently conducted.

Meanwhile, the negotiation apparatus 1 according to this example embodiment is configured to calculate a utility value of demand conditions using a utility function based on resource information and decide a negotiation operation based on the calculated utility value. Accordingly, it is possible to decide the negotiation operation capable of efficiently making the benefit for the organization (company or the like) larger in accordance with the demand conditions. In particular, even in complex negotiations in which the demand conditions include a plurality of elements, the negotiation apparatus 1 according to this example embodiment is able to efficiently decide such a negotiation operation that makes the benefit for the organization (company or the like) larger. Therefore, the negotiation apparatus 1 according to this example embodiment is able to efficiently conduct negotiations that are appropriate for the organization.

Further, the negotiation apparatus 1 according to this example embodiment is able to perform the negotiation operation for securing new slots for supplying resources (supply capabilities), whereby it is possible to efficiently decide not only a negotiation operation between two parties but also a negotiation operation among three or more parties. That is, the negotiation apparatus 1 according to this example embodiment is able to decide to conduct negotiations with an entity (e.g., a supplier) other than the customer when new slots are required since the number of slots for supplying the resources is not sufficient with the current resource information. Therefore, with the negotiation apparatus 1 according to this example embodiment, it becomes possible to efficiently conduct negotiations that are appropriate for the organization even in complex negotiations such as negotiations conducted among three or more parties.

It is possible to efficiently conduct negotiations that are appropriate for the organization by a negotiation method executed by the negotiation apparatus 1 as well. Further, by using the program for executing the negotiation method as well, negotiations that are appropriate for the organization can be efficiently conducted. Further, with the negotiation system composed of a plurality of negotiation apparatuses 1, it is possible to efficiently conduct appropriate negotiations from each standpoint of the organizations that use the negotiation apparatuses 1.

### First Example Embodiment

Hereinafter, with reference to the drawings, example embodiments will be described. In order to clarify the explanation, the following descriptions and the drawings are omitted and simplified as appropriate. Further, throughout the drawings, the same components are denoted by the same reference symbols and overlapping descriptions are omitted as necessary.

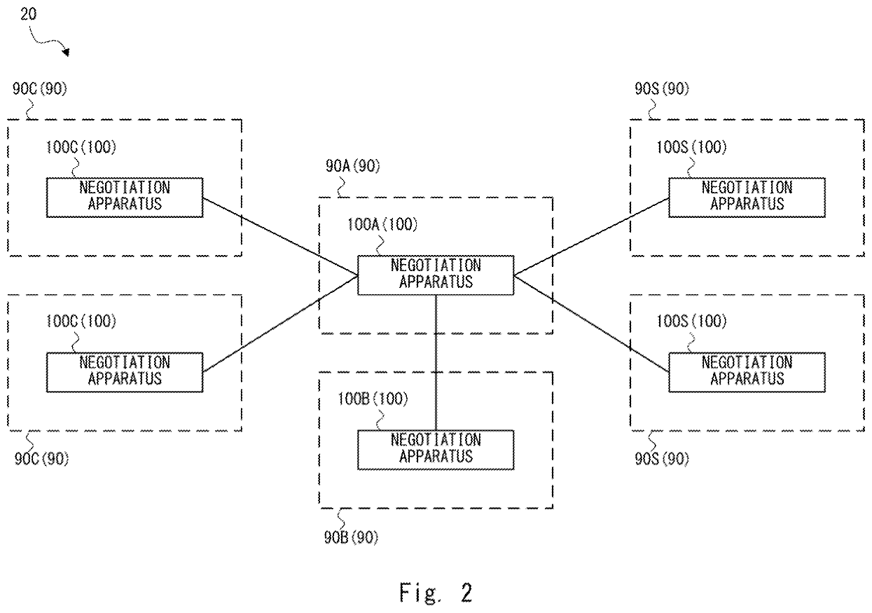

FIG. 2 is a diagram showing a configuration of a negotiation system 20 according to the first example embodiment. The negotiation system 20 includes a plurality of negotiation apparatuses 100. Each of the negotiation apparatuses 100 corresponds to the negotiation apparatus 1 shown in FIG. 1. The negotiation apparatuses 100 are, for example, computers. Each of the negotiation apparatuses 100 is used by an organization such as a company which is the subject of negotiations. That is, the negotiation apparatus 100 is provided for each organization. The negotiation apparatuses 100 may be connected to one another, for example, via a wired or wireless network so that they can communicate with one another. Further, the plurality of negotiation apparatuses 100 may be implemented, for example, by cloud computing. In this case, the plurality of negotiation apparatuses 100 may not be physically separated from one another.

In the example shown in FIG. 2, a negotiation apparatus 100A is connected to negotiation apparatuses 100C, negotiation apparatuses 100S, and a negotiation apparatus 100B in such a way that the negotiation apparatus 100A is able to communicate with them. For an organization 90A in which the negotiation apparatus 100A is provided, an organization 90C where the negotiation apparatus 100C is provided may be a customer in a business deal. The organization 90A provides a commodity or a service (hereinafter referred to as a commodity or the like) for the organization 90C, which corresponds to a customer, using one or more resources in a business deal between the organization 90C and the organization 90A.

Further, for the organization 90A, an organization 90S in which the negotiation apparatus 100S is provided may be a supplier who provides a necessary resource. In this case, the organization 90S may supply a resource required to provide the commodity or the like that the organization 90A supplies to the organization 90C in the business deal between the organization 90C and the organization 90A. Therefore, for the organization 90S, the organization 90A may be a customer. Further, an organization 90B in which the negotiation apparatus 100B is provided may provide a commodity or the like that is substantially similar to the commodity or the like that the organization 90A supplies. Therefore, for the organization 90A, the organization 90B may be a company operating in the same industry. Then, when the respective organizations 90 are assumed to be layers of supply chains, if the organization 90A is assumed to be in a layer n, the organization 90S is in the layer n+1, the organization 90C is in the layer n−1, and the organization 90B is in the layer n.

If, for example, a business deal A has been proposed from the organization 90C for requesting the organization 90A to provide a commodity A, the negotiation apparatus 100A calculates a utility value of demand conditions that correspond to a business deal A in accordance with resource information in the organization 90A. Then, the negotiation apparatus 100A decides a negotiation operation in accordance with the calculated utility value. The negotiation apparatus 100A may conduct automatic negotiations by autonomously transmitting information for executing the negotiation operation to another negotiation apparatus 100 (e.g., the negotiation apparatus 100C or the negotiation apparatus 100S). Alternatively, the negotiation apparatus 100A may output the decided negotiation operation in such a manner that the user of the organization 90A can recognize this negotiation operation. Accordingly, the user is able to execute the decided negotiation operation.

If it is possible to secure the resource required for the commodity A under conditions in which the utility value exceeds a predetermined threshold from the current resource information, the negotiation apparatus 100A may decide to accept the business deal A as the negotiation operation. Further, if there is no condition in which the utility value exceeds the predetermined threshold with the current resource information in order to secure resources required for the commodity A, the negotiation apparatus 100A may decide to perform a negotiation operation for changing a slot for supplying each resource in the availability status of the resource information. This means, for example, to decide, in order to secure the slot to be changed, to conduct negotiations with the organization 90S to request the organization 90S to supply the resource that corresponds to this slot. In this manner, the negotiation apparatus 100A according to the first example embodiment decides the negotiation operation using the utility value calculated in accordance with the resource information, whereby it is possible to decide the negotiation operation in such a way that the benefit for the organization 90A becomes large using the resources that the organization 90A can use. The details thereof will be described later.

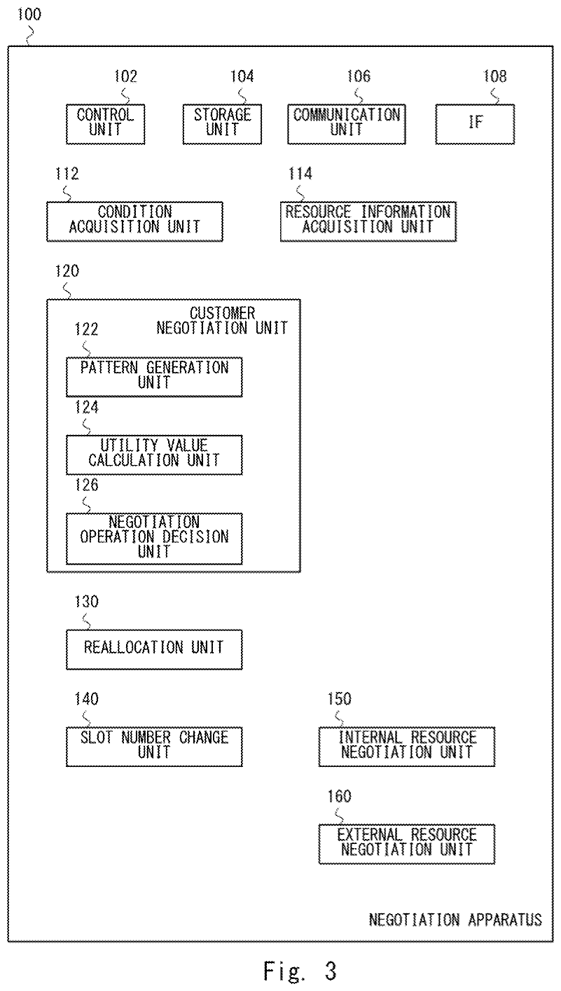

FIG. 3 is a diagram showing a configuration of the negotiation apparatus 100 according to the first example embodiment. Each of the plurality of negotiation apparatuses 100 shown in FIG. 2 may include the configuration as shown in FIG. 3. Hereinafter, if the plurality of negotiation apparatuses 100 shown in FIG. 2 are mentioned without distinguishing among them, the organization 90 in which the negotiation apparatus 100 regarding which the explanation is being made is provided is simply referred to as an “organization 90”.

The negotiation apparatus 100 includes, as main hardware configurations, a control unit 102, a storage unit 104, a communication unit 106, and an interface unit (IF) 108. The control unit 102, the storage unit 104, the communication unit 106, and the interface unit 108 are connected to one another via a data bus or the like.

The control unit 102 is, for example, a processor such as a Central Processing Unit (CPU). The control unit 102 has a function as an arithmetic apparatus that performs, for example, control processing and arithmetic processing. The storage unit 104 is, for example, a storage device such as a memory or a hard disc. The storage unit 104 is, for example, a Read Only Memory (ROM) or a Random Access Memory (RAM). The storage unit 104 has a function for storing, for example, a control program(s) and an arithmetic program(s) executed by the control unit 102. Further, the storage unit 104 has a function for temporarily storing processing data and the like. The storage unit 104 may include a database.

The communication unit 106 performs processing necessary for communicating with other apparatuses such as another negotiation apparatus 100 via a network. The communication unit 106 may include, for example, a communication port, a router, and a firewall. The interface unit (IF) 108 is, for example, a user interface (UI). The interface unit 108 includes an input device such as a keyboard, a touch panel, or a mouse, and an output device such as a display or a speaker. The interface unit 108 receives an operation of inputting data performed by a user (operator) and outputs information to the user. The interface unit 108 may display information regarding the decided negotiation operation.

The negotiation apparatus 100 according to the first example embodiment includes, as components, a condition acquisition unit 112, a resource information acquisition unit 114, a customer negotiation unit 120, a reallocation unit 130, a slot number change unit 140, an internal resource negotiation unit 150, and an external resource negotiation unit 160. The customer negotiation unit 120 includes a pattern generation unit 122, a utility value calculation unit 124, and a negotiation operation decision unit 126.

The condition acquisition unit 112 corresponds to the condition acquisition unit 2 shown in FIG. 1. The condition acquisition unit 112 includes a function as condition acquisition means. The resource information acquisition unit 114 includes a function as resource information acquisition means. The customer negotiation unit 120 includes a function as customer negotiation means. The reallocation unit 130 includes a function as reallocation means. The slot number change unit 140 includes a function as slot number change means. The internal resource negotiation unit 150 includes a function as internal resource negotiation means (resource negotiation means). The external resource negotiation unit 160 includes a function as external resource negotiation means (resource negotiation means). The pattern generation unit 122 includes a function as pattern generation means.

The utility value calculation unit 124 corresponds to the calculation unit 4 shown in FIG. 1. The utility value calculation unit 124 includes a function as utility value calculation means. The negotiation operation decision unit 126 corresponds to the operation decision unit 6 shown in FIG. 1. The negotiation operation decision unit 126 includes a function as negotiation operation decision means.

Note that each of the aforementioned components may be implemented, for example, by executing a program under the control of the control unit 102. More specifically, each of the components may be implemented by the control unit 102 executing a program stored in the storage unit 104. Further, each of the components may be implemented by installing a necessary program stored in any nonvolatile recording medium as required. Further, each of the components is not necessarily implemented by software executed by a program, and may instead be implemented, for example, by any combination of hardware, firmware, and software. Further, each of the components may also be implemented using a user-programmable integrated circuit, such as a field-programmable gate array (FPGA) or a microcomputer. In this case, a program composed of each of the aforementioned components may be implemented by using this integrated circuit. The same is applicable to other example embodiments that will be described later. The specific functions of the respective components will be described later.

The condition acquisition unit 112 acquires the aforementioned demand conditions (business deal conditions or demand forecast conditions). When a business deal from a customer has arrived, the condition acquisition unit 112 acquires information indicating the business deal conditions. The business deal conditions may include information regarding, for example, a product, the delivery date, the expense, the quantity and the like desired by the customer as elements. The condition acquisition unit 112 may acquire information indicating the business deal conditions from the negotiation apparatus 100 of the customer via the communication unit 106. Alternatively, when the business deal conditions are input by the user, the condition acquisition unit 112 may acquire information indicating the business deal conditions via the interface unit 108.

Further, the condition acquisition unit 112 acquires the demand forecast conditions at a desired timing. The demand forecast conditions are conditions regarding the future demand forecast. The demand forecast conditions relate to the demand (business deal) forecasted from the past history of demand. The elements of the demand forecast conditions may indicate, for example, a product expected to be in demand in the future, the delivery date (period when demand is increased), the expense, and the quantity. The demand forecast conditions may be indicated, for example, by a demand forecast distribution indicating a relation between a period and the demand. The demand forecast distribution may be, for example, business deal arrival forecast distribution indicating a distribution of the probability that a business deal arrives in a certain period of time. With this demand forecast distribution, as will be described later, slots in the resource information may be secured in advance in such a way that products can be manufactured in a period in which it is forecasted that demand will be increased. The demand forecast conditions may be generated by a learned model generated by machine learning using past transaction data as training data. Note that the condition acquisition unit 112 may acquire demand forecast conditions stored in the storage unit 104. Alternatively, the condition acquisition unit 112 may acquire information indicating the demand forecast conditions from an apparatus other than the negotiation apparatus 100 via the communication unit 106.

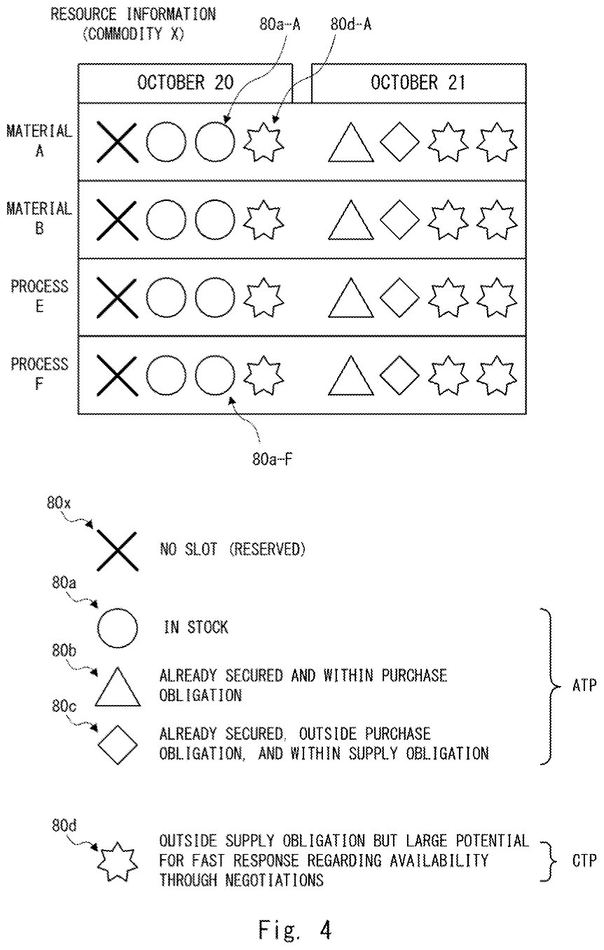

The resource information acquisition unit 114 acquires the aforementioned resource information. The resource information indicates an availability status of a plurality of resources required to provide a commodity or the like. That is, a commodity or the like may be provided using a plurality of resources. While the resources required to provide a commodity or the like include, for example, materials (components) and processes (manufacturing processes), this is merely one example. The resources managed by the resource information may be any one of those stated above or may be other resources. Examples of the resource information will be described later with reference to FIG. 4.

When the resource information is stored in the storage unit 104, the resource information acquisition unit 114 acquires the resource information from the storage unit 104. Further, when the resource information is stored in an apparatus other than the negotiation apparatus 100, the resource information acquisition unit 114 acquires the resource information via the communication unit 106. Further, when the resource information is input by the user, the resource information acquisition unit 114 acquires the resource information via the interface unit 108. Further, the resource information acquisition unit 114 may retrieve information stored in an apparatus other than the negotiation apparatus 100 and generate (acquire) the resource information.

FIG. 4 is a diagram illustrating the resource information according to the first example embodiment. In the example shown in FIG. 4, a material A, a material B, a process E, and a process F are shown as the resources required to provide one commodity X. That is, in the resource information illustrated in FIG. 4, management of manufacturing of one commodity X may be managed using the material A, the material B, the process E, and the process F. Then, in the example shown in FIG. 4, the commodity X may be manufactured using all of the material A, the material B, the process E, and the process F. Further, in the example shown in FIG. 4, for each resource, four slots are provided in one day. While slots are managed for each date in the resource information shown in FIG. 4, it is not required to manage the slots by the date or the time axis.

In the resource information illustrated in FIG. 4, a slot 80x shown by X is a slot that has already been reserved (reserved slot) for a certain demand. That is, resources that are required to meet a certain demand have already been allocated to the respective slots 80x. On the other hand, resources that are required to meet the demand have not yet been allocated to slots 80a, 80b, and 80c, and 80d. That is, the slots 80a, 80b, 80c, and 80d are unoccupied slots.

The slots 80a, 80b, and 80c are slots regarding ATP (ATP slots). The slot 80a shown by a circle indicates “in stock”. The slot 80b shown by a triangle is a slot indicating “already secured and within purchase obligation”. That is, the slot 80b is a slot in which there is a commitment that the corresponding resource will be definitely purchased from a supplier. The slot 80c shown by a rhombus is a slot indicating “already secured, outside purchase obligation, and within supply obligation”. That is, the slot 80c is a slot in which there is a commitment that the corresponding resource will be definitely supplied from a supplier if the organization 90 sends a request although the organization 90 is not obligated to purchase the corresponding resource from the supplier. Further, the slot 80d shown by a star is a slot regarding CTP (CTP slot). The slot 80d is a slot indicating “outside supply obligation but large potential for fast response regarding availability through negotiations”. That is, the slot 80d is a slot indicating that it is highly likely that it will be supplied as a result of negotiations with the supplier although the supplier is not obligated to supply the corresponding resource to the organization 90. Note that the above three types regarding the attributes of the slots regarding ATP are merely examples, and are not limited to the above three types.

The attributes regarding the loss and gain when the organization 90 uses the corresponding resource are associated with each slot 80 (unoccupied slot). For example, regarding one resource, for each of the slots 80, the cost, the quality, and the delivery date may be different from each other. For example, regarding one resource, the cost for allocating this resource in the slot 80d may be higher than the cost for allocating the same resource in the other unoccupied slots. For example, regarding the process F, a slot 80a-F is associated with the attributes such as “quality: high, cost: 300 yen”. Further, regarding the material A, a slot 80a-A is associated with the attributes such as “quality: high, date of stocking: October 18, price: 1000 yen”. Further, regarding the material A, a slot 80d-A is associated with the attributes such as “supplier: Company A, price: expected to be 1200 yen or higher”. As will be described later, the customer negotiation unit 120 inputs these attributes into a utility function, thereby calculating a utility value of the demand conditions using the resource information.

In the example shown in FIG. 4, regarding the material A, of the four slots on October 20, one is the slot 80x, two slots are the slots 80a, and the one remaining slot is the slot 80d. Further, regarding the material A, of the four slots on October 21, one slot is the slot 80b, one slot is the slot 80c, and the two remaining slots are the slot 80d.

The customer negotiation unit 120 (FIG. 3) performs processing regarding negotiations with a customer. The customer negotiation unit 120 may control the operations of the reallocation unit 130, the slot number change unit 140, the internal resource negotiation unit 150, and the external resource negotiation unit 160. The pattern generation unit 122 generates a plurality of feasible patterns in accordance with the resource information. Specifically, the pattern generation unit 122 generates a plurality of patterns (reservation patterns) for allocating resources required to provide a commodity or the like according to the demand conditions to the unoccupied slots in the resource information. The details thereof will be described later.

The utility value calculation unit 124 calculates the utility value of the acquired demand conditions using a predetermined utility function. Specifically, the utility value calculation unit 124 calculates the utility value for each of the plurality of reservation patterns generated by the pattern generation unit 122. The utility value may vary depending on how the resources regarding the demand conditions are allocated to the unoccupied slots in the resource information. The details thereof will be described later. The parameter of the utility function may be set as appropriate by the user.

The negotiation operation decision unit 126 decides the negotiation operation based on the utility value calculated by the utility value calculation unit 124. Specifically, the negotiation operation decision unit 126 decides the negotiation operation in accordance with the reservation pattern in which the utility value exceeds the predetermined threshold. Further specifically, the negotiation operation decision unit 126 decides the negotiation operation in accordance with the reservation pattern in which the utility value becomes a maximum among the utility values that exceed the threshold. The negotiation operation decision unit 126 decides, for example, whether to accept the business deal conditions based on the utility value. Further, the reallocation unit 130, the slot number change unit 140, the internal resource negotiation unit 150, and the external resource negotiation unit 160 may operate in accordance with the operation decided by the negotiation operation decision unit 126. The details thereof will be described later. The threshold compared to utility values may indicate the limitation that the benefit for the organization 90 can be obtained. That is, when a utility value is equal to or smaller than the threshold, it means that it is possible that the benefit for the organization 90 may not be obtained with the reservation pattern. The threshold may be set as appropriate by the user.

The reallocation unit 130 performs reallocation processing. The reallocation unit 130 selects a pattern after the reallocation based on the utility value of the demand conditions calculated using the predetermined utility function for each of a plurality of patterns configured by virtually performing reallocation for the slots where resources have already been allocated in the availability status of the resource information. Specifically, regarding resources related to the demand conditions, the reallocation unit 130 performs reallocation by switching reserved slots with unoccupied slots in the resource information in a plurality of patterns. Further, the reallocation unit 130 calculates the utility value using a predetermined utility function for each pattern (reallocation pattern) of the slots of the resource information that have been reallocated. Therefore, the reallocation unit 130 may function as calculation means for calculating the utility value as well. Further, the utility function regarding the reallocation unit 130 may be different from the utility function regarding the customer negotiation unit 120 (the utility value calculation unit 124). Further, the reallocation unit 130 selects the pattern after the reallocation based on the utility value calculated for each reallocation pattern. Note that the demand conditions according to the reallocation unit 130 may either be business deal conditions or demand forecast conditions. The reallocation unit 130 may perform the reallocation processing at a desired timing. The details of the processing in the reallocation unit 130 will be described later.

The slot number change unit 140 performs slot number change processing. The slot number change unit 140 selects, for each of the plurality of patterns configured by virtually changing the number of slots for supplying each resource in the availability status of the resource information, a pattern after the number of slots has been changed based on the utility value of the demand conditions calculated using a predetermined utility function. Specifically, regarding resources related to the demand conditions, the slot number change unit 140 virtually changes the number of unoccupied slots in the resource information in a plurality of patterns. Accordingly, the pattern in which the number of slots has been changed (slot number change pattern) is generated. Further, the slot number change unit 140 calculates, for each slot number change pattern, the utility value using the predetermined utility function. Therefore, the slot number change unit 140 may function as calculation means for calculating utility values as well. Further, the utility function regarding the slot number change unit 140 may be different from the utility functions regarding the customer negotiation unit 120 (the utility value calculation unit 124) and the reallocation unit 130. Further, the slot number change unit 140 selects, based on the utility value calculated for each slot number change pattern, the pattern after the number of slots has been changed. The slot number change unit 140 may perform the slot number change processing at a desired timing. The details of the processing in the slot number change unit 140 will be described later.

The internal resource negotiation unit 150 performs processing for conducting negotiations regarding whether or not resources inside the organization 90 (internal resources) are available. The “internal resources” here are resources that may be allocated depending on negotiations to slots that are different from the slots allocated in advance to the resource information regarding one commodity X (in the example shown in FIG. 4, four slots in one day). For example, an internal resource regarding the material A may correspond to the material A that is in stock and is required to supply a commodity X′ that is different from the commodity X but requires the resource A. Further, an internal resource regarding the process F may correspond to the manpower obtained by overtime work or the like. The internal resource negotiation unit 150 generates new business deal conditions regarding a new business deal related to the resources allocated to slots that have been changed as a result of a change in the number of slots based on the conditions regarding the slot number change pattern in which the utility value exceeds the threshold. Further, the internal resource negotiation unit 150 determines whether or not new business deal conditions are met in accordance with the response information generated by another negotiation apparatus in accordance with business deal conditions. The response information, which is information regarding resources allocated to the slots that have been changed, may indicate information indicating whether to accept the business deal, and a counterproposal when the business deal is not accepted.

The external resource negotiation unit 160 performs processing for conducting negotiations regarding whether or not resources outside the organization 90 (external resources) are available. The “external resources” are resources that may be supplied from another organization through negotiations. The external resource negotiation unit 160 generates new business deal conditions regarding a new business deal related to the resources allocated to slots that have been changed in accordance with the change in the number of slots based on the conditions regarding the slot number change pattern in which the utility value exceeds the threshold. Further, the external resource negotiation unit 160 determines whether or not new business deal conditions are met in accordance with the response information regarding the resources allocated to the slots that have been changed, the response information being generated by another negotiation apparatus depending on the business deal conditions. The internal resource negotiation unit 150 and the external resource negotiation unit 160 may perform processing regarding negotiations also in a case in which a CTP slot has been reserved for one resource. In this case, business deal conditions that will be described later may be known information, like in a case in which a contract has already been signed with the partner, and business deal generation rules that will be described later may be defined in such a way that conditions negotiated before are issued.

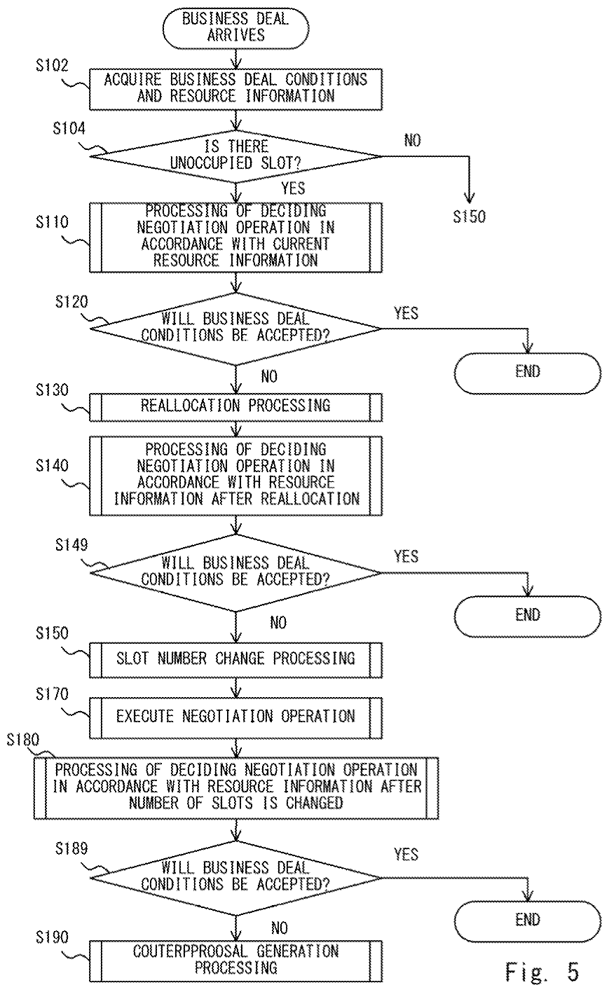

FIG. 5 is a flowchart showing a negotiation method executed by the negotiation apparatus 100 according to the first example embodiment. FIG. 5 shows a flowchart showing a negotiation method when a business deal has arrived. Note that the process flow shown in FIG. 5 is merely one example and the flow of the negotiation method is not limited to the one shown in FIG. 5.

First, when a business deal from the customer has arrived, the negotiation apparatus 100 acquires business deal conditions and resource information (Step S102). Specifically, the condition acquisition unit 112 acquires business deal conditions X, which are demand conditions. At this time, the condition acquisition unit 112 may further acquire demand forecast conditions. The business deal conditions X relate to, for example, the commodity X manufactured using the resources (the material A, the material B, the process E, and the process F) managed in the resource information illustrated in FIG. 4. In this case, the business deal conditions may include information such as (commodity X, delivery date: October 20). The resource information acquisition unit 114 further acquires resource information indicating the current availability status of the resources in the organization 90. The resource information acquisition unit 114 acquires, for example, the resource information illustrated in FIG. 4.

The customer negotiation unit 120 determines whether or not there is an unoccupied slot for a resource regarding the business deal conditions in the current resource information (Step S104). When there is an unoccupied slot in the current resource information (YES in S104), the customer negotiation unit 120 performs processing of deciding the negotiation operation in accordance with the current resource information (Step S110). The processing of S110 will be described later. Then, the negotiation operation decision unit 126 decides a negotiation operation that corresponds to the results of the processing of S110. On the other hand, when there is no unoccupied slot in the current resource information (NO in S104), the negotiation operation decision unit 126 decides to perform slot number change processing. Then the processing proceeds to S150.

When the result of the processing of S110 shows that the business deal conditions will be accepted (YES in Step S120), the processing is ended. In this case, the customer negotiation unit 120 may automatically transmit response information indicating that the business deal will be accepted to the negotiation apparatus 100 of the organization 90, i.e., a customer (the same is applicable to “a case in which the business deal conditions are accepted” that will be explained later). On the other hand, when the result of the processing of S110 shows that the business deal conditions will not be accepted (NO in S120), the negotiation operation decision unit 126 decides to perform the reallocation processing. Then, according to the control of the customer negotiation unit 120, the reallocation unit 130 executes the reallocation processing (Step S130). The processing of S130 will be described later. Then, the customer negotiation unit 120 performs processing of deciding the negotiation operation in accordance with the resource information after the reallocation (Step S140). The processing of S140 will be described later.

Then, the negotiation operation decision unit 126 decides the negotiation operation that corresponds to the results of the processing of S140. When the result of the processing of S140 shows that the business deal conditions will be accepted (YES in Step S149), the processing is ended. On the other hand, when the result of the processing of S140 shows that the business deal conditions will not be accepted (NO in S149), the negotiation operation decision unit 126 decides to perform the slot number change processing. Then, according to the control of the customer negotiation unit 120, the slot number change unit 140 executes slot number change processing (Step S150). The processing of S150 will be described later. Then, the negotiation apparatus 100 (at least one of the internal resource negotiation unit 150 and the external resource negotiation unit 160) executes the negotiation operation in accordance with the result of the processing of S150 (Step S170). The processing of S150 and S170 will be described later.

Then, the customer negotiation unit 120 performs processing of deciding the negotiation operation in accordance with the resource information after the number of slots is changed (Step S180). The processing of S180 will be described later. Then, the negotiation operation decision unit 126 decides the negotiation operation that corresponds to the result of the processing of S180. When the result of the processing of S180 shows that the business deal conditions will be accepted (YES in Step S189), the processing is ended. On the other hand, when the result of the processing of S180 shows that the business deal conditions will not be accepted (NO in S189), the negotiation operation decision unit 126 generates a counterproposal (Step S190). The processing of S180 and S190 will be described later. Note that the processing of S130 and the processing of S150 may be performed at desired timings.

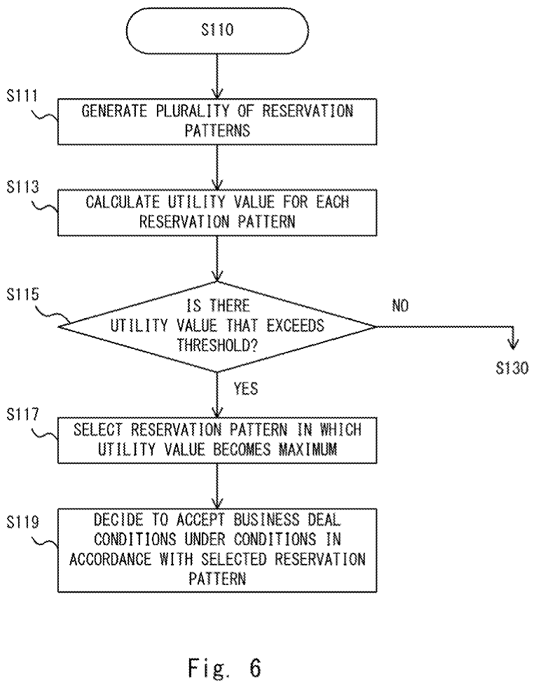

FIG. 6 is a flowchart showing the details of the processing of S110 shown in FIG. 5. The pattern generation unit 122 of the customer negotiation unit 120 generates a plurality of reservation patterns (Step S111). Specifically, the pattern generation unit 122 generates a plurality of reservation patterns by allocating the resources required to provide a commodity or the like regarding the business deal to unoccupied slots.

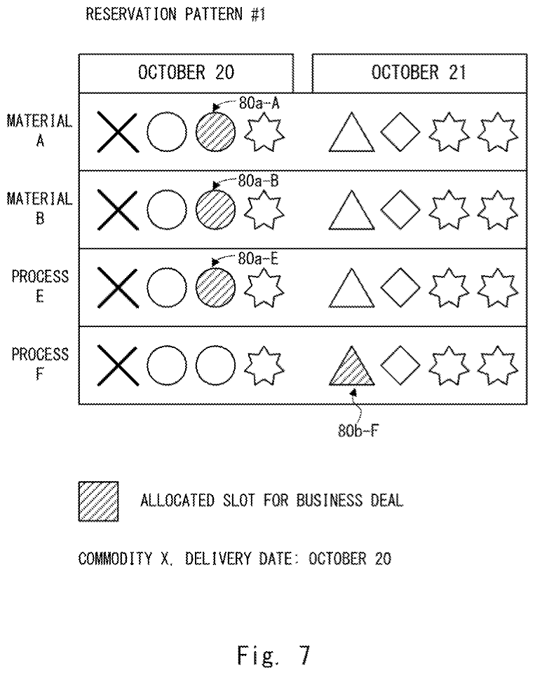

FIGS. 7-9 are diagrams illustrating reservation patterns generated in the processing of S111 shown in FIG. 6. In the examples shown in FIGS. 7-9, resources according to the business deal conditions X are allocated to slots 80a-80d, which are unoccupied slots in the resource information illustrated in FIG. 4. In a reservation pattern #1 illustrated in FIG. 7, the material A is allocated to the slot 80a-A on October 20. The material B is allocated to a slot 80a-B on October 20. The process E is allocated to a slot 80a-E on October 20. The process F is allocated to a slot 80b-F on October 21.

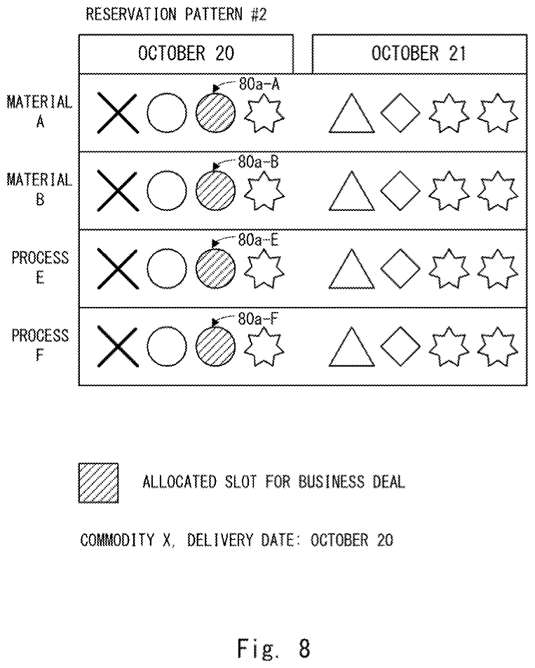

In a reservation pattern #2 illustrated in FIG. 8, the material A is allocated to the slot 80a-A on October 20. The material B is allocated to the slot 80a-B on October 20. The process E is allocated to the slot 80a-E on October 20. The process F is allocated to the slot 80a-F on October 20.

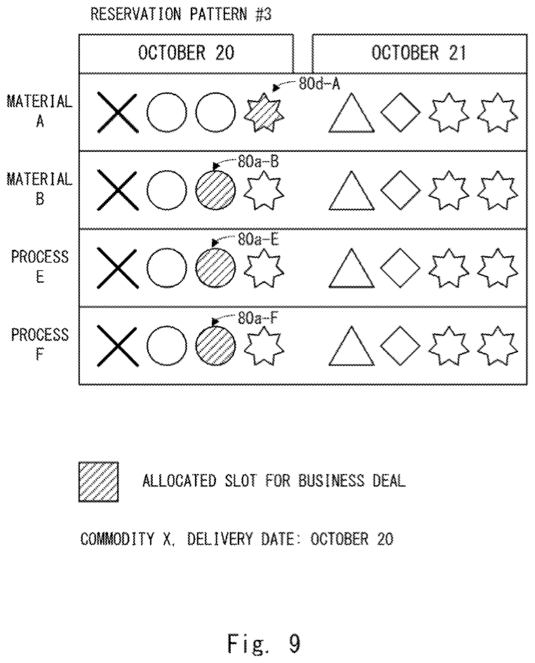

In a reservation pattern #3 illustrated in FIG. 9, the material A is allocated to the slot 80d-A on October 20. The material B is allocated to the slot 80a-B on October 20. The process E is allocated to the slot 80a-E on October 20. The process F is allocated to the slot 80a-F on October 20.

The utility value calculation unit 124 calculates, using the utility function, the utility value for each of the plurality of reservation patterns generated in the processing of S111 (Step S113). That is, the utility value calculation unit 124 calculates the utility value of the business deal conditions for each of a plurality of patterns (reservation patterns) configured in accordance with which one of a plurality of slots in the current availability status in the resource information one or more resources that are necessary for business deal conditions will be allocated to. Specifically, the utility value calculation unit 124 inputs, for each of the reservation patterns, the attributes of the slot 80 to which one resource is allocated into the utility function, computes the utility function, and calculates the utility value.

A utility function F1 in the customer negotiation unit 120 can be expressed, for example, by the following Expression 1.

F1=f1+g1 (1)

The function f1 can be expressed, for example, by the following Expression 2.

f1(selling price,buying price)=selling price−buying price (2)

Further, the function g1 can be expressed, for example, by the following Expression 3.

$$g 1 ( Desired delivery date , Date of provision ) = \{ \begin{matrix}- ∞ & \begin{matrix}if ( Desired delivery date \\ - Date of provision ) < 0\end{matrix} \\ \begin{matrix}\begin{matrix}a - \\ ( Desired delivery date -\end{matrix} \\ {Date of provision )}^{2}\end{matrix} & else if\end{matrix} \qquad ( 3 )$$

The function f1 is a function regarding the profit of the organization 90. Further, the function g1 is a function regarding the delivery date. The conditions in the upper stage correspond to the detriment to the company (the organization 90) for failing to meet the customer's desired delivery date and the conditions in the lower stage correspond to the inventory management cost in the organization 90. The symbol a in the function g1 is a parameter regarding the inventory management cost. Further, the “selling price” of the function f1 and the “desired delivery date” of the function g1 may be given depending on the business deal conditions X. That is, the “selling price” of the function f1 and the “desired delivery date” of the function g1 are matters agreed with the customer. On the other hand, the “buying price” of the function f1 and the “date of provision” of the function g1 may be given in accordance with the attributes of the slot 80 to which a resource has been allocated in a reservation pattern.

The utility value calculation unit 124 calculates, for each reservation pattern, the utility value F1 (reservation pattern), which is the value of the utility function F1. Then, the negotiation operation decision unit 126 determines whether or not there is a utility value that exceeds a predetermined threshold (Step S115). That is, the negotiation operation decision unit 126 determines whether or not the utility values regarding the respective reservation patterns exceed the predetermined threshold. Specifically, the negotiation operation decision unit 126 determines whether or not there is a reservation pattern #x in which the following Expression 4 is established.

F1(reservation pattern #x)>t1 (4)

Note that t1 is a predetermined threshold. The threshold t1 may be set as appropriate by the user. The threshold t1 is related to the benefit for the organization 90. When a utility value exceeds the threshold t1, it means that it is possible to provide a commodity or the like while keeping the customer's desired delivery date and ensuring the benefit that the organization 90 requires. The processing of S115 may be a determination regarding whether or not f1 (the reservation pattern #x)>tf1 and g1 (the reservation pattern #x)>tg1 are established (the same is applicable to the processing of S145 and S185 that will be described later). The symbols tf1 and tg1 are predetermined thresholds. The threshold tf1 is related to the benefit with respect to the price. Further, the threshold tg1 is related to the benefit with respect to the delivery date. The aforementioned utility function and thresholds may be set as appropriate so as to meet the purpose of the organization 90 (that is, in such a way that the benefit for the organization 90 is increased). The same is applicable to other utility functions and thresholds that will be described later.

When there is a utility value that exceeds the threshold (YES in S115), the negotiation operation decision unit 126 selects the reservation pattern in which the utility value becomes a maximum (Step S117). Then, the negotiation operation decision unit 126 decides to accept the business deal under the conditions in accordance with the selected reservation pattern (Step S119, YES in S120). On the other hand, when there is no utility value that exceeds the threshold (NO in S115), the processing proceeds to S130. That is, the negotiation operation decision unit 126 decides to perform the reallocation processing (S130). The processing of S130 will be described later.

In the reservation pattern #1 shown in FIG. 7, the date of the slot 80 to which the process F is allocated is later than the desired delivery date.

Therefore, since it is only after October 21 that the commodity A can be provided, (desired delivery date−date of provision)<0 is established. Therefore, since g1=−∞ is established from Expression 3, the utility value F1 (the reservation pattern #1) becomes equal to or smaller than the threshold t1. It is assumed, in the reservation pattern #2 shown in FIG. 8 and the reservation pattern #3 shown in FIG. 9, the utility value exceeds the threshold t1. That is, F1 (the reservation pattern #2)>t1 and F1 (the reservation pattern #3)>t1 are established.

Further, when F1 (the reservation pattern #2) is compared with F1 (the reservation pattern #3), in the reservation pattern #2, the material A is allocated to the slot 80a. On the other hand, in the reservation pattern #3, the material A is allocated to the slot 80d. As described above, it is highly likely that the cost of the slot 80d-A will be higher than the cost of the slot 80a-A. Therefore, from Expression 2, f1 (the reservation pattern #2) becomes larger than f1 (the reservation pattern #3). Therefore, F1 (the reservation pattern #2)>F1 (the reservation pattern #3)>t1 is established. Therefore, the negotiation operation decision unit 126 selects the reservation pattern #2. Then, the negotiation operation decision unit 126 decides to accept the business deal conditions under the conditions regarding the reservation pattern #2.

As described above, the customer negotiation unit 120 is configured to calculate, for each of the plurality of reservation patterns obtained using the resource information, the utility value of the business deal conditions and decide the negotiation operation in accordance with the reservation pattern in which the utility value exceeds the threshold. Therefore, it becomes possible, for example, to conduct appropriate negotiations so that the benefit for the organization 90 can be obtained more efficiently. Further, the customer negotiation unit 120 is configured to decide the negotiation operation in accordance with the reservation pattern in which the utility value becomes a maximum among utility values that exceed the threshold. Therefore, it becomes possible to efficiently conduct such negotiations that the benefit for the organization 90 becomes a maximum.

While the utility function is a sum of the function f1 and the function g1 in the example in Expression 1, this is merely one example. The utility function F1 may either be the function f1 or the function g1. Alternatively, the utility function may be a product of the function f1 and the function g1. When F1=f1 is established, the reservation pattern in which f1 (reservation pattern)>t1 may be selected. Further, when F1=g1 is established, the reservation pattern in which g1 (reservation pattern)>t1 may be selected. Further, the aforementioned utility function is merely one example and the utility function may be set in a desired manner for each organization 90 or for each resource. The same is applicable to the other utility functions that will be described below.

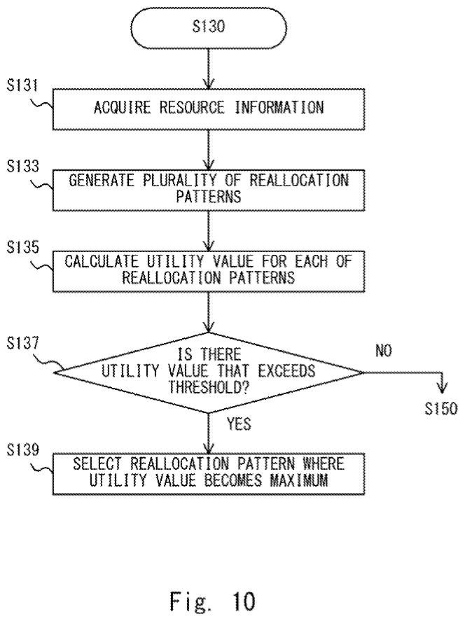

FIG. 10 is a flowchart showing details of the reallocation processing (S130) shown in FIG. 5. The reallocation unit 130 acquires the resource information (Step S131). The reallocation unit 130 generates a plurality of reallocation patterns (Step S133). Specifically, as described above, regarding resources related to the demand conditions, the reallocation unit 130 performs reallocation by switching reserved slots (slots 80x) with unoccupied slots (slots 80a or the like) regarding the resource information in a plurality of patterns.

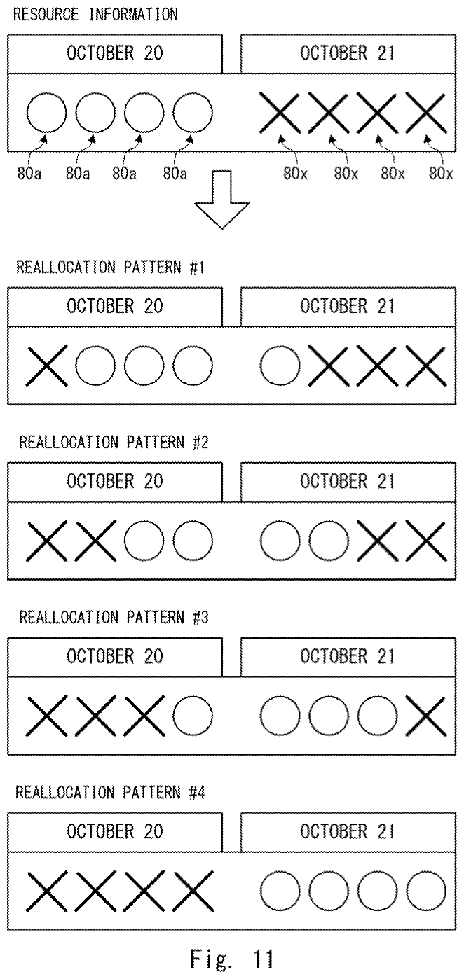

FIG. 11 is a diagram for describing a reallocation method according to the first example embodiment. It is assumed, for example, that, regarding one resource, in the current availability status in the resource information, there are four unoccupied slots (e.g., the slots 80a) on October 20 and four reserved slots (the slots 80x) on October 21. In this case, the reallocation unit 130 randomly switches unoccupied slots on October 20 with reserved slots on October 21. As a result, for example, four reallocation patterns #1-#4 illustrated in FIG. 11 are generated.

In the reallocation pattern #1, there are three unoccupied slots and one reserved slot on October 20 and there are three reserved slots and one unoccupied slot on October 21. In the reallocation pattern #2, there are two unoccupied slots and two reserved slots on October 20 and there are two reserved slots and two unoccupied slots on October 21. In the reallocation pattern #3, there is one unoccupied slot and three reserved slots on October 20 and there are one reserved slot and three unoccupied slots on October 21. In the reallocation pattern #4, there are four reserved slots on October 20 and four unoccupied slots on October 21. While the period in which unoccupied slots and reserved slots can be switched is set to be two days (October 20 and October 21) in the example shown in FIG. 11, this period is merely an example. This period may be set as appropriate by the user.

Next, the reallocation unit 130 calculates, using the utility function, the utility value for each of the plurality of reallocation patterns generated in the processing of S133 (Step S135). Specifically, the reallocation unit 130 inputs, for each of the reallocation patterns, the parameter regarding the demand forecast conditions into the utility function, computes the utility function, and calculates the utility value.

A utility function F2 in the reallocation unit 130 may be expressed, for example, by the following Expression 5.

F2=f2+g2 (5)

The function f2 is expressed, for example, by the following Expression 6.

f2=(expected benefit according to the business deal arrival forecast distribution in the reallocation pattern #x)−(expected benefit according to the business deal arrival forecast distribution in the pattern of the resource information before the reallocation) (6)

Further, the function g2 can be expressed, for example, by the following Expression 7.

$$g 2 ( Desired delivery date , Date of provision ) = \{ \begin{matrix}- ∞ & \begin{matrix}if ( Desired delivery date \\ - Date of provision ) < 0\end{matrix} \\ \begin{matrix}\begin{matrix}a - \\ ( Desired delivery date -\end{matrix} \\ {Date of provision )}^{2}\end{matrix} & else if\end{matrix} \qquad ( 7 )$$

The function f2 is a function regarding the profit of the organization 90. Further, the function g2 is a function regarding the delivery date. The conditions in the upper stage correspond to the detriment to the company (the organization 90) for failing to meet the customer's desired delivery date and the conditions in the lower stage correspond to the inventory management cost in the organization 90. Note that the expected benefit in the business deal arrival forecast distribution becomes large if there are many unoccupied slots on a day when demand increases in the business deal arrival forecast distribution. Further, the “desired delivery date” in Expression 7 corresponds to the desired delivery date of a commodity or the like in a reserved slot and the “date of provision” in Expression 7 corresponds to the date of a reserved slot after switching. The utility function F2 may be expressed as shown in the following Expression 8 in consideration of the business deal conditions that have actually arrived.

F2=(f1+f2)+(g1+g2) (8)

Further, the utility function F2 may be such a function that has a large value when leveled in such a manner that reserved slots are not concentrated in a specific date.

The reallocation unit 130 determines whether or not there is a utility value that exceeds a predetermined threshold (Step S137). That is, the reallocation unit 130 determines whether utility values regarding the respective reallocation patterns exceed the predetermined threshold. Specifically, the reallocation unit 130 determines whether or not there is a reallocation pattern #x where the following Expression 9 is established.

F2(reallocation pattern #x)>t2 (9)

The symbol t2 is a predetermined threshold. The threshold t2 may be set as appropriate by the user. The threshold t2 is related to the benefit for the organization 90. When the utility value exceeds the threshold t2, it means that it is possible to provide a commodity or the like so as to meet the demand conditions while keeping the desired delivery date in the business deal regarding reserved slots and ensuring the benefit that the organization 90 requires.

When there is a utility value that exceeds the threshold (YES in S137), the reallocation unit 130 selects the reallocation pattern where the utility value becomes a maximum (Step S139). Then the processing proceeds to S140 that will be described later. On the other hand, when there is no utility value that exceeds the threshold (NO in S137), the reallocation unit 130 does not perform reallocation. In this case, the negotiation operation decision unit 126 decides to perform slot number change processing (S150). Then the processing proceeds to S150 that will be described later.

When, for example, F2 (reallocation pattern #2)>F2 (reallocation pattern #x)>t2 (where x=1, 3, 4) is established, the reallocation unit 130 selects the reallocation pattern #2. In this case, the reallocation unit 130 decides to move two of the four reserved slots on October 21 to October 20 and to thus provide two unoccupied slots on October 21. Accordingly, for example, two commodities A (or resources A or the like) that should have been manufactured on October 21 are to be manufactured on October 20. Accordingly, the difference between the desired delivery date and the date of provision becomes large, which decreases the value of g2, whereas the value of the utility function F2 becomes a maximum. While the reallocation unit 130 selects the reallocation pattern where the utility value becomes a maximum in the aforementioned example, this is merely one example. When, for example, the number of unoccupied slots is small, the reallocation unit 130 may select reallocation patterns of the top n (n is an integer equal to or larger than 1) utility values.

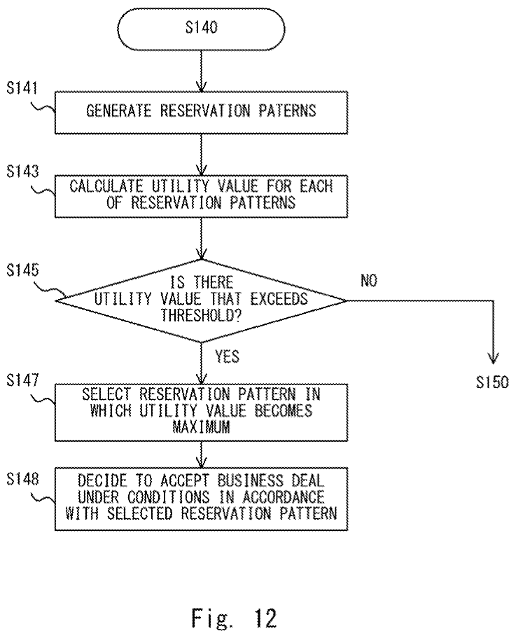

FIG. 12 is a flowchart showing details of the processing of S140 shown in FIG. 5. The pattern generation unit 122 of the customer negotiation unit 120 generates one or more reservation patterns for the reallocation pattern selected in the processing of S139 (Step S141). Specifically, the pattern generation unit 122 generates one or more reservation patterns (reservation pattern after the reallocation) by allocating resources required to provide a commodity or the like regarding a business deal to unoccupied slots in the reallocation pattern. When the reallocation unit 130 has selected reallocation patterns of the top n utility values, the pattern generation unit 122 may generate, for each of the n reallocation patterns that have been selected, a reservation pattern (reservation pattern after the reallocation).

The utility value calculation unit 124 calculates the utility value for each of the reservation patterns generated in the processing of S141 using the utility function (Step S143). That is, the utility value calculation unit 124 calculates the utility value of the business deal conditions for each of the patterns configured in accordance with which one of the slots in the pattern after the reallocation selected by the reallocation unit 130 one or more resources that are necessary for business deal conditions will be allocated to. Specifically, the utility value calculation unit 124 inputs, for each of the reservation patterns after the reallocation, attributes of the slot 80 to which one resource has been allocated into the utility function, computes the utility function, and calculates the utility value. Note that the utility function may be the one expressed by the above-described Expression 1.

Then, the negotiation operation decision unit 126 determines whether or not there is a utility value that exceeds a predetermined threshold (Step S145). Specifically, the negotiation operation decision unit 126 determines whether or not there is a reservation pattern #x in which the above-described Expression 4 is established. Then, when there is a utility value that exceeds the threshold (YES in S145), the negotiation operation decision unit 126 selects the reservation pattern in which the utility value becomes a maximum (Step S147). Then, the negotiation operation decision unit 126 decides to accept the business deal under the conditions in accordance with the selected reservation pattern (Step S148, YES in S149). On the other hand, when there is no utility value that exceeds the threshold (NO in S145), the processing proceeds to S150. That is, the negotiation operation decision unit 126 decides to perform slot number change processing. The processing of S150 will be described later.

As described above, the reallocation unit 130 calculates the utility value of the demand conditions using a predetermined utility function for each of a plurality of patterns configured by virtually performing allocation for the slots where resources have already been allocated in the availability status of the resource information. Then, the reallocation unit 130 selects the pattern after the reallocation based on the calculated utility value. Accordingly, it is possible to select a reallocation pattern with which a commodity or the like can be provided so as to meet the demand conditions while keeping the desired delivery date in the business deal regarding the reserved slots and ensuring the benefit that the organization 90 requires. Then, by deciding the negotiation operation from the utility values of the respective reservation patterns composed of the selected reallocation pattern, it becomes possible to conduct appropriate negotiations even in a case in which it is impossible to conduct appropriate negotiations for the organization 90 with the current resource information.

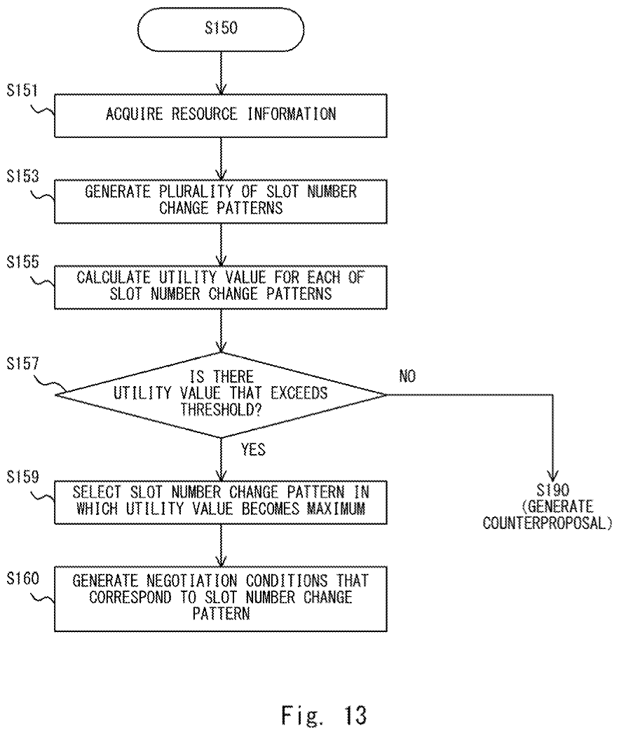

FIG. 13 is a flowchart showing details of the slot number change processing (S150) shown in FIG. 5. The slot number change unit 140 acquires the resource information (Step S151). The slot number change unit 140 generates a plurality of slot number change patterns (Step S153). Specifically, as described above, the slot number change unit 140 changes, for a resource regarding the demand conditions, the number of slots by virtually changing the number of unoccupied slots (the number of slots) in a plurality of patterns. Note that changing of the number of slots includes increasing of the number of slots (the number of unoccupied slots) and decreasing of the number of slots (the number of unoccupied slots). In the following description, a case in which the number of slots is increased will be mainly explained.

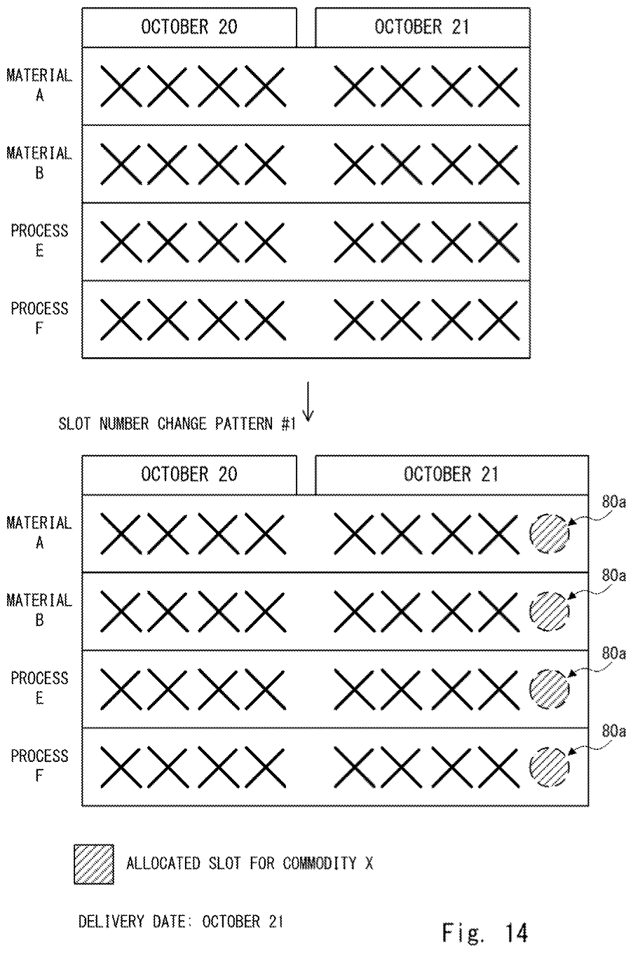

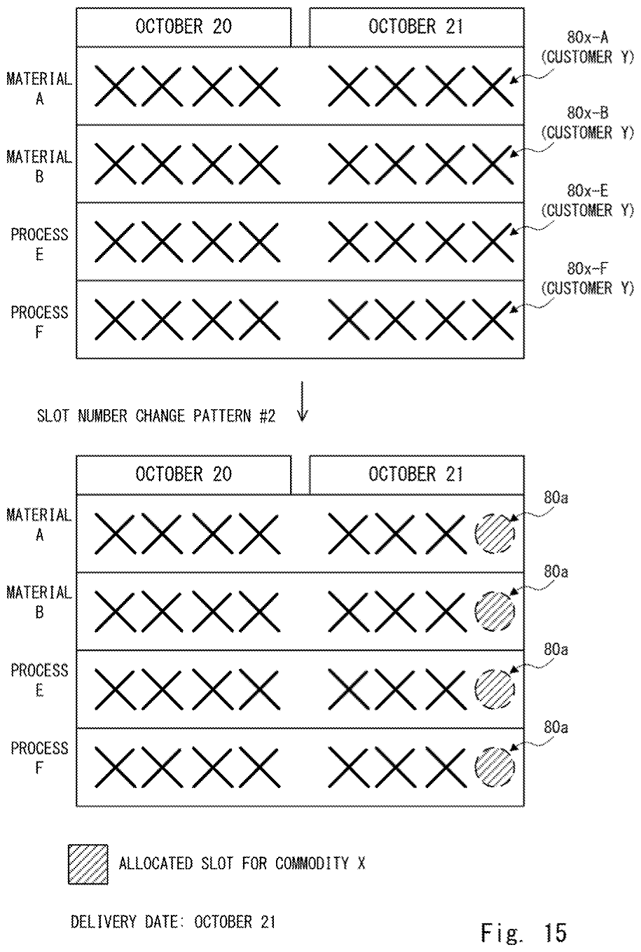

FIGS. 14 and 15 are diagrams for describing a method for changing the number of slots according to the first example embodiment. It is assumed, for example, that the delivery date of the commodity X, that is, the demand date of the commodity X is October 21 in the business deal arrival forecast distribution. It is further assumed, for all the resources regarding the commodity X, that all the slots on October 20 and 21 have already been reserved. In this case, in the example shown in FIG. 14, for all the resources, the number of unoccupied slots (the slots 80a) on October 21 is virtually increased. Accordingly, the total number of slots on October 21 is increased from four to five. The slot number change pattern #1 is thus generated. Further, in the example shown in FIG. 15, for all the resources, the business deals regarding the slots 80x-A, 80x-B, 80x-E, and 80x-F on October 21 that have already been reserved for one customer Y are cancelled, whereby the number of unoccupied slots (the slots 80a) is virtually increased. In this case, the total number of slots on October 21 remains to be four. The slot number change pattern #2 is thus generated. While the period in which the number of unoccupied slots is changed is two days (from October 20 to October 21) in the examples shown in FIGS. 14 and 15, this period is merely an example. This period may be set as appropriate by the user. The aforementioned example may be applied also to a case in which the delivery date is October 21 for the business deal regarding the commodity X that has been actually arrived. That is, even in a case in which a business deal has actually arrived, the slot number change patterns illustrated in FIGS. 14 and 15 may be generated.

Next, the slot number change unit 140 calculates the utility value for each of the plurality of slot number change patterns generated in the processing of S153 using the utility function (Step S155). Specifically, the slot number change unit 140 inputs, for each of the slot number change patterns, parameters regarding the demand forecast conditions into the utility function, computes the utility function, and calculates the utility value.

A utility function F3 in the slot number change unit 140 may be expressed, for example, by the following Expression 10.

F3=f3 (10)

The function f3 is expressed, for example, by the following Expression 11.

f3=(expected benefit according to business deal arrival forecast distribution)−(cost due to the increase in the number of slots) (11)

The function f3 is a function regarding the profit of the organization 90. Further, “expected benefit according to business deal arrival forecast distribution” is expected benefit that is based on the business deal arrival forecast distribution and is caused by the slots being occupied (business deal is concluded). Further, “cost due to the increase in the number of slots” may be, for example, in a case in which the total number of slots increases, as illustrated in FIG. 14, the cost for increasing the inventory. Further, in a case in which the reserved business deal is cancelled, as illustrated in FIG. 15, “cost due to the increase in the number of slots” may be lost profits caused by the cancelling. Note that the slot number change unit 140 may have only the function of calculating the utility value when the reserved business deal has been cancelled, and negotiations related to the cancelling of the business deal may be performed by the customer negotiation unit 120 or the like. Alternatively, the slot number change unit 140 may conduct the negotiations related to the cancelling of the business deal.

Note that the utility function F3 may be the one in which a function regarding the delivery date (inventory cost) such as the function g1 or g2 is added to the function f3. Further, the utility function F3 may be expressed as shown in the following Expression 12 in consideration of the actually arrived business deal conditions.

F3=(f1+f3)+(g1) (12)

The slot number change unit 140 determines whether or not there is a utility value that exceeds a predetermined threshold (Step S157). That is, the slot number change unit 140 determines whether or not the utility values regarding the respective slot number change patterns exceed a predetermined threshold. Specifically, the slot number change unit 140 determines whether or not there is a slot number change pattern #x in which the following Expression 13 is established.

F3(slot number change pattern #x)>t3 (13)

Note that t3 is a predetermined threshold. The threshold t3 may be set as appropriate by the user. The threshold t3 is related to the benefit for the organization 90. When the utility value exceeds the threshold t3, it means that it is possible to provide a commodity or the like so as to meet the demand conditions while ensuring the benefit that the organization 90 requires.

When there is a utility value that exceeds the threshold (YES in S157), the slot number change unit 140 selects a slot number change pattern in which the utility value becomes a maximum (Step S159). Then, the slot number change unit 140 generates negotiation conditions that correspond to the selected slot number change pattern and outputs the generated negotiation conditions to the internal resource negotiation unit 150 and the external resource negotiation unit 160 (Step S160). Then the processing proceeds to S170. The method for generating the negotiation conditions will be described later. On the other hand, when there is no utility value that exceeds the threshold (NO in S157), the slot number change unit 140 does not perform the slot number change processing. In this case, the negotiation operation decision unit 126 decides to generate a counterproposal. Then the processing proceeds to S190. The method for generating the counterproposal will be described later.

When, for example, F3 (slot number change pattern #2)>F3 (slot number change pattern #x)>t3 (where x=1), the slot number change unit 140 selects the slot number change pattern #2. In this case, the slot number change unit 140 cancels the reserved slots of the respective resources regarding the business deal conditions Y with the customer Y on October 21 and decides to make these slots unoccupied ones. Accordingly, it is possible to provide resources, for example, for business deal conditions X (presented by the customer X) that are more advantageous for the organization 90 than the originally reserved business deal conditions Y (presented by the customer Y). On the other hand, when F3 (slot number change pattern #1)>F3 (slot number change pattern #x)>t3 (where x=2), the slot number change unit 140 selects the slot number change pattern #1. In this case, the slot number change unit 140 decides to increase the number of slots of each of the resources on October 21 by one. Accordingly, it is possible to provide resources for, for example, the business deal conditions Y that may be presented (presented by the customer Y). While the slot number change unit 140 selects the slot number change pattern in which the utility value becomes a maximum in the aforementioned example, this is merely one example. The slot number change unit 140 may select the slot number change patterns of the top n (n is an integer equal to or larger than 1) utility values. In this case, negotiation conditions that correspond to n respective slot number change patterns may be generated in the processing of S160.

Further, from the utility function F3 illustrated in Expression 12, even when the demand date (delivery date) in the business deal arrival forecast is not met in the current resource information, it may be possible to secure slots allocated to the resources necessary for the commodity or the like according to the business deal conditions. When the date when demand increases in the business deal arrival forecast distribution is October 21, business deal conditions cannot be accepted if the current resource information is in the state as shown in the upper diagrams of FIGS. 14 and 15. However, if the slot number change pattern in which the utility value exceeds the threshold with the utility function F3 illustrated in Expression 12 is selected, in this slot number change pattern, the number of slots for allocating the necessary resources is increased in such a way that the demand date of October 21 is met.

Further, from the utility function F3 illustrated in Expression 12, even if the delivery date in the business deal conditions that have actually arrived is not met in the current resource information, it may be possible to secure slots allocated to the resources necessary for the commodity or the like according to the business deal conditions. When, for example, the delivery date in the business deal conditions that have actually arrived is October 21, if the current resource information is in the state as shown in the upper diagrams of FIGS. 14 and 15, the business deal conditions cannot be accepted. However, when the slot number change pattern in which the utility value exceeds the threshold with the utility function F3 illustrated in Expression 12 is selected, in this slot number change pattern, the number of slots for allocating the necessary resources is increased in such a way that the delivery date of October 21 is met.

Now, the negotiation conditions will be described. The negotiation conditions are conditions under which the internal resource negotiation unit 150 and the external resource negotiation unit 160 conduct negotiations. The slot number change unit 140 generates, in accordance with predetermined negotiation rules, negotiation conditions ω that correspond to the selected slot number change pattern in such a way that the benefit for the organization 90 occurs. The negotiation conditions ω may include, for example, resources, delivery date, price, quantity and the like that correspond to the slots increased in the slot number change pattern as elements. Note that the negotiation conditions ω may correspond to the aforementioned business deal conditions from the viewpoint of the negotiation partner, i.e., the organization which supplies the resources.

Further, the negotiation rules are set in such a way that the negotiation conditions ω are generated so that the value of the utility function F3 that has received the negotiation conditions ω exceeds the threshold t3. For example, the negotiation rules may be set in such a way that the price in the negotiation conditions ω becomes equal to (the cost due to the increase in the number of slots)+t3+α3. Further, the negotiation rules may be set in such a way that the delivery date in the negotiation conditions ω becomes equal to (the date in which the number of slots is increased in the slot number change pattern)−m3. Note that α3 and m3 may be set as appropriate by the user or may be an optimum value obtained by machine learning. The negotiation rules may be set in such a way that the negotiation conditions ω are generated so that the value of the utility function F1 that has received the negotiation conditions ω exceeds the threshold t1.

In a case in which, for example, it is expected that demand will decrease according to the business deal arrival forecast distribution, as described above, the slot number change unit 140 may generate a slot number change pattern in which the number of unoccupied slots (the number of slots) is decreased, and calculate the utility value for this slot number change pattern. The function f3 in the utility function F3 when the number of slots is decreased is expressed, for example, by the following Expression 14.

f3=(benefit obtained by decreasing the number of slots)−(cost due to adjustment of the number of slots) (14)

The “benefit obtained by decreasing the number of slots” includes, for example, benefit obtained by decreasing the cost of procuring the resources that correspond to the slots to be decreased, and benefit obtained by decreasing the inventory cost.

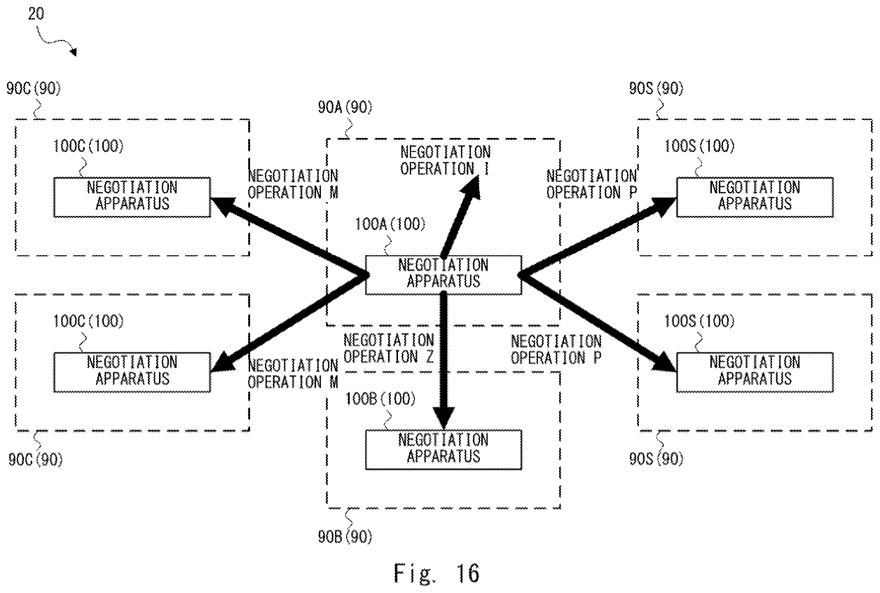

FIG. 16 is a diagram for describing negotiation operations for increasing the number of slots according to the first example embodiment. FIG. 16 shows negotiation operations seen from the organization 90A shown in FIG. 2. A negotiation operation I is a negotiation operation for securing slots for allocating the internal resources of the organization 90A. This negotiation operation I may be executed by the internal resource negotiation unit 150.

A negotiation operation P is a negotiation operation for securing slots by procuring resources from the organization 90S (layer n+1), which corresponds to the supplier. A negotiation operation Z is a negotiation operation for securing slots by procuring resources from the organization 90B (layer n), which corresponds to the company operating in the same industry. A negotiation operation M is a negotiation operation for securing slots to be allocated to resources regarding a business deal from another customer by cancelling the business deal that has arrived from the organization 90C, which corresponds to the customer, and has already been accepted. The negotiation operations P, Z, and M may be executed by the external resource negotiation unit 160.

By the aforementioned processing performed by the slot number change unit 140, one of the aforementioned negotiation operations in which a good value of the utility function F3 can be obtained may be decided. The slot number change unit 140 compares, for example, the utility value for the slot number change pattern that corresponds to the negotiation operation M (the slot number change pattern #2 illustrated in FIG. 15) with the utility value for the slot number change pattern that corresponds to the negotiation operation P (the slot number change pattern #1 illustrated in FIG. 14). When the utility value of the slot number change pattern that corresponds to the negotiation operation P is larger than the utility value of the slot number change pattern that corresponds to the negotiation operation M, it can be determined that canceling a business deal is more costly than ordering additional resources. Therefore, in this case, it is decided to select the slot number change pattern that corresponds to the negotiation operation P and to perform the negotiation operation P.

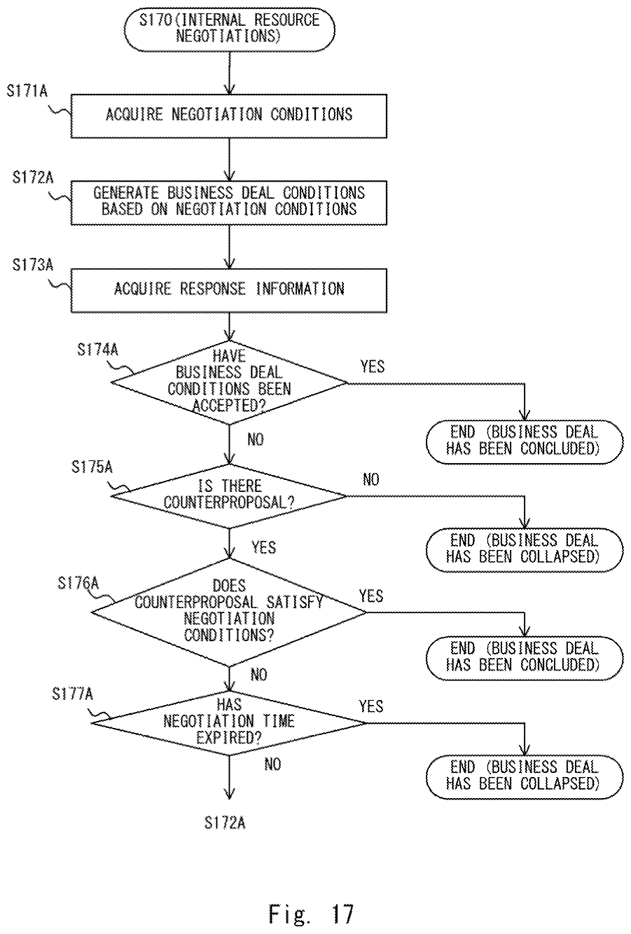

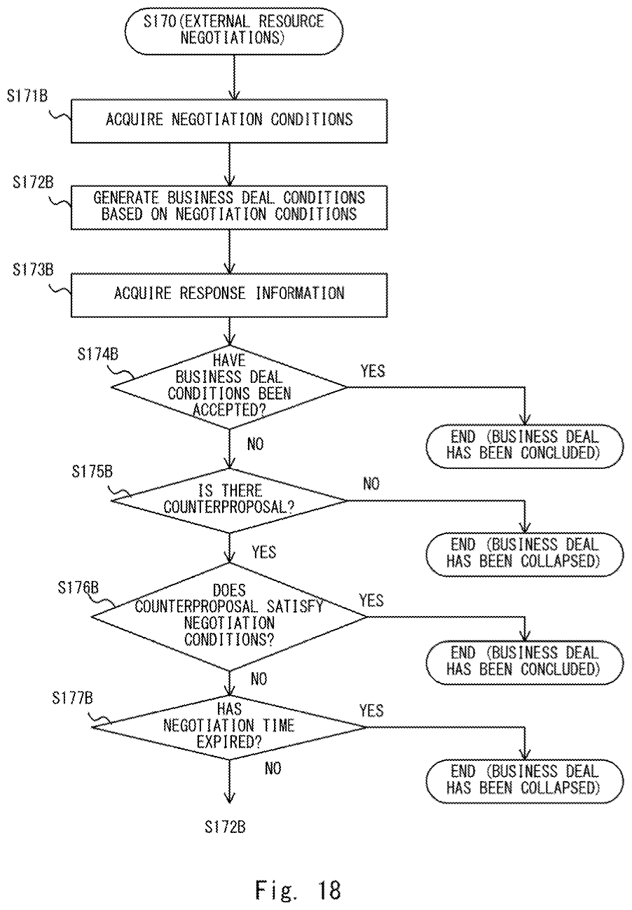

FIGS. 17 and 18 are flowcharts showing the details of the negotiation operation execution processing (S170) shown in FIG. 5. FIG. 17 is a flowchart showing negotiation operation execution processing by the internal resource negotiation unit 150. FIG. 18 is a flowchart showing the negotiation operation execution processing by the external resource negotiation unit 160. When the business deal is concluded by the processing of S170, slots may be actually secured. When the business deal has not concluded in any negotiation operation in the processing of S170, the processing of S190 may be performed. In the following descriptions regarding FIGS. 17 and 18, the operation in the negotiation apparatus 100A of the organization 90A in FIG. 16 will be described.

The flowchart shown in FIG. 17 will be described. The internal resource negotiation unit 150 acquires the negotiation conditions ω from the slot number change unit 140 (Step S171A). The internal resource negotiation unit 150 generates new business deal conditions based on the negotiation conditions ω (Step S172A). Note that the internal resource negotiation unit 150 may transmit the generated business deal conditions to the negotiation apparatus 100 of the negotiation partner via the communication unit 106. Alternatively, the internal resource negotiation unit 150 may output the generated business deal conditions to the interface unit 108 and the user may input the output business deal conditions into the negotiation apparatus 100 of the negotiation partner. The “negotiation apparatus 100 of the negotiation partner” here means another negotiation apparatus 100 provided in the same organization 90A.

For example, the internal resource negotiation unit 150 generates business deal conditions f4(ω) by predetermined business deal generation rules f4 and the negotiation conditions ω. It is assumed, for example, that ω=(run the line, assemble two products X, YY (month) ZZ (date)). These negotiation conditions are conditions that “run the line and assemble two products X by YY (month) ZZ (date)”. Further, it is assumed that f4 be “randomly generate one business deal that satisfies the acquired negotiation conditions ω”. In this case, the internal resource negotiation unit 150 generates, for example, business deal conditions f4(ω) expressed by the following Expression 15.

f4(ω)=(run the line,two people with specific skills,three hours) (15)

The above business deal conditions mean “run the line and have two workers with specific skills work for three hours”.

Then, the internal resource negotiation unit 150 acquires response information regarding the business deal conditions f4 from the negotiation partner (Step S173A). The internal resource negotiation unit 150 may acquire the response information by receiving the response information from the negotiation apparatus 100 of the negotiation partner via the communication unit 106. Alternatively, the user inputs the response information output from the negotiation apparatus 100 of the negotiation partner using the interface unit 108, whereby the internal resource negotiation unit 150 may acquire the response information. Note that the response information may include information indicating that the negotiation partner has accepted the business deal conditions f4(ω) or a counterproposal ω′. The method for generating the counterproposal ω′ is substantially similar to a method in S190 that will be described later.

The internal resource negotiation unit 150 determines whether or not the response information indicates that the business deal conditions have been accepted (Step S174A). When the response information indicates that the business deal conditions have been accepted (YES in S174A), the internal resource negotiation unit 150 determines that the business deal has been concluded and ends the processing. On the other hand, when the response information does not indicate that the business deal conditions have been accepted (NO in S174A), the internal resource negotiation unit 150 determines whether or not there is a counterproposal in the response information (Step S175A). When there is no counterproposal (NO in S175A), the internal resource negotiation unit 150 determines that the business deal has been collapsed and ends the processing.

On the other hand, when there is a counterproposal (YES in S175A), the internal resource negotiation unit 150 determines whether or not the counterproposal ω′ satisfies the negotiation conditions ω (Step S176A). It is assumed, in the aforementioned example, that the counterproposal ω′ is ω′=(run the line and have three workers with specific skills work for two hours). This counterproposal means “run the line and have three workers with specific skills work for two hours”. Then, the internal resource negotiation unit 150 determines whether or not the counterproposal ω′ is consistent with the negotiation conditions ω, and determines, when they are consistent with each other, that the counterproposal ω′ satisfies the negotiation conditions ω.

When the counterproposal ω′ satisfies the negotiation conditions ω (YES in S176A), the internal resource negotiation unit 150 determines that the business deal has been concluded and ends the processing. On the other hand, when the counterproposal ω′ does not satisfy the negotiation conditions ω (NO in S176A), the internal resource negotiation unit 150 determines whether or not a predetermined negotiation time has expired (Step S177A). In the processing of S177A, it may be determined whether or not the number of times of negotiations (the number of times of communication including transmission of the business deal conditions and reception of the response information) has exceeded a predetermined number of times, instead of determining whether the negotiation time has expired. When the negotiation time has expired (YES in S177A), the internal resource negotiation unit 150 determines that the business deal has been collapsed and ends the processing. On the other hand, when the negotiation time has expired (NO in S177A), the internal resource negotiation unit 150 repeats the processing from S172. In this case, the generated business deal conditions are preferably different from the business deal conditions that have already been generated.

The flowchart shown in FIG. 18 will be described. The external resource negotiation unit 160 acquires the negotiation conditions ω from the slot number change unit 140 (Step S171B). The external resource negotiation unit 160 generates new business deal conditions based on the negotiation conditions ω (Step S172B). The external resource negotiation unit 160 may transmit the generated business deal conditions to the negotiation apparatus 100 of the negotiation partner via the communication unit 106. Alternatively, the external resource negotiation unit 160 may output the generated business deal conditions to the interface unit 108 and the user may input the output business deal conditions to the negotiation apparatus 100 of the negotiation partner. The “negotiation apparatus 100 of the negotiation partner” here is another negotiation apparatus 100 that is provided in an organization 90 that is different from the organization 90A. Then, the external resource negotiation unit 160 may perform the negotiation operation P and the negotiation operation Z in parallel to each other. The external resource negotiation unit 160 may transmit the business deal conditions to a plurality of organizations 90S in parallel to each other. Further, the external resource negotiation unit 160 may transmit the business deal conditions to the organization 90S in an order listed in a predetermined list.

The external resource negotiation unit 160 generates, for example, business deal conditions f5(ω) by predetermined business deal generation rules f5 and the negotiation conditions ω. It is assumed, for example, that a business deal that has arrived from the organization 90C to the organization 90A is related to provision of “automobiles”. It is assumed, in this case, for example, that ω=(engine, two, 40,000 yen or lower). These negotiation conditions mean that “the supplier (organization 90S) provides two engines for 40,000 yen or lower” (that is, “the organization 90A purchases two engines for 40,000 yen or lower”. The same is applicable to business deal conditions described below). Further, it is assumed that f5 is “to randomly generate one business deal that satisfies the acquired negotiation conditions ω”. In this case, the external resource negotiation unit 160 generates, for example, business deal conditions f5(ω) expressed by the following Expression 16.

f5(ω)=(engine,two,30,000 yen) (16)

The above business deal conditions mean that “the supplier provides two engines for 30,000 yen”.

Then, the external resource negotiation unit 160 acquires response information regarding the business deal conditions f5 from the negotiation partner (Step S173B). The external resource negotiation unit 160 may acquire the response information by receiving the response information from the negotiation apparatus 100 of the negotiation partner via the communication unit 106. Alternatively, the external resource negotiation unit 160 may acquire the response information by inputting, by the user, the response information output from the negotiation apparatus 100 of the negotiation partner using the interface unit 108. The response information may include information indicating that the negotiation partner has accepted the business deal conditions f5(ω) or a counterproposal ω′. The method for generating the counterproposal ω′ will be described later.

The external resource negotiation unit 160 determines whether or not the response information indicates that the business deal conditions have been accepted (Step S174B). When the response information indicates that the business deal conditions have been accepted (YES in S174B), the external resource negotiation unit 160 determines that the business deal has been concluded and ends the processing. On the other hand, when the response information does not indicate that the business deal conditions have been accepted (NO in S174B), the external resource negotiation unit 160 determines whether or not there is a counterproposal in the response information (Step S175B). When there is no counterproposal (NO in S175B), the external resource negotiation unit 160 determines that the business deal has been collapsed and ends the processing.

On the other hand, when there is a counterproposal (YES in S175B), the external resource negotiation unit 160 determines whether or not the counterproposal ω′ satisfies the negotiation conditions ω (Step S176B). It is assumed, in the aforementioned example, that the counterproposal ω′ is ω′=(engine, two, 50,000 yen). The counterproposal means that “the supplier provides two engines for 50,000 yen”. Then, the external resource negotiation unit 160 determines whether or not the counterproposal ω′ is consistent with the negotiation conditions ω. When they are consistent with each other, the external resource negotiation unit 160 determines that the counterproposal ω′ satisfies the negotiation conditions ω.

When the counterproposal ω′ satisfies the negotiation conditions ω (YES in S176B), the external resource negotiation unit 160 determines that the business deal has been concluded and ends the processing. On the other hand, when the counterproposal ω′ does not satisfy the negotiation conditions ω (NO in S176B), the external resource negotiation unit 160 determines whether a predetermined negotiation time has expired (Step S177B). Alternatively, in the processing of S177B, the external resource negotiation unit 160 may determine whether the number of times of negotiations (the number of times of communication including transmission of the business deal conditions and reception of the response information) has exceeded a predetermined number of times, instead of determining whether or not the negotiation time has expired. When the negotiation time has expired (YES in S177B), the external resource negotiation unit 160 determines that the business deal has been collapsed and ends the processing. On the other hand, when the negotiation time has expired (NO in S177B), the external resource negotiation unit 160 repeats the processing from S172. The business deal conditions generated at this time are preferably different from the business deal conditions that have already been generated. Since the aforementioned counterproposal ω′ does not satisfy the negotiation conditions ω, the business deal conditions are generated again if the negotiation time has not expired.

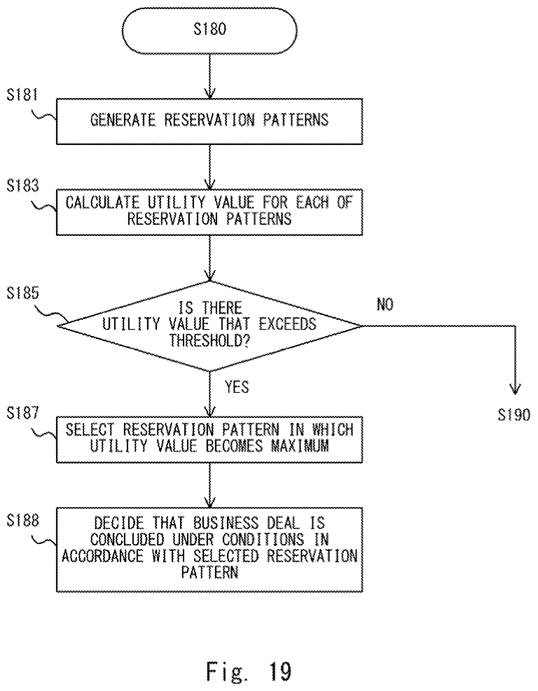

FIG. 19 is a flowchart showing the details of the processing of S180 shown in FIG. 5. The pattern generation unit 122 of the customer negotiation unit 120 generates one or more reservation patterns for the slot number change pattern selected in the processing of S159 (Step S181). Specifically, the pattern generation unit 122 generates one or more reservation patterns (reservation pattern(s) after the slot number has been changed) by allocating resources that are required to provide a commodity or the like regarding the business deal to unoccupied slots in the slot number change pattern.

The utility value calculation unit 124 calculates the utility value for each of the reservation patterns generated in the processing of S181 using the utility function (Step S183). That is, the utility value calculation unit 124 calculates the utility value of the business deal conditions for each of the patterns configured in accordance with which one of the slots in the pattern after the number of slots has been changed selected by the slot number change unit 140 one or more resources that are necessary for the business deal conditions will be allocated to. Specifically, the utility value calculation unit 124 inputs, for each of the reservation patterns after the number of slots has been changed, the negotiation conditions ω generated in S160 or the counterproposal ω′ into the utility function, computes the utility function, and calculates the utility value. The utility function may be the one expressed by the aforementioned Expression 1.

Then, the negotiation operation decision unit 126 determines whether or not there is a utility value that exceeds a predetermined threshold (Step S185). Specifically, the negotiation operation decision unit 126 determines whether or not there is a reservation pattern #x where the above-described Expression 4 is established. When there is a utility value that exceeds the threshold (YES in S185), the negotiation operation decision unit 126 selects the reservation pattern in which the utility value becomes a maximum (Step S187). Then, the negotiation operation decision unit 126 decides to accept the business deal under the conditions in accordance with the selected reservation pattern (Step S188, YES in S189).

On the other hand, when there is no utility value that exceeds the threshold (NO in S185), the processing proceeds to S190. That is, the negotiation operation decision unit 126 decides to generate a counterproposal. Accordingly, the customer negotiation unit 120 generates a counterproposal ω₀′ to the business deal conditions ω₀ from the customer (S190). The method for generating the counterproposal will be described later.

As described above, the slot number change unit 140 calculates, for each of a plurality of patterns configured by virtually changing the number of slots for supplying each resource in the availability status of the resource information, the utility value of the demand conditions using a predetermined utility function. Then, the slot number change unit 140 selects, based on the calculated utility value, the pattern after the number of slots has been changed. Accordingly, the number of slots regarding the resources that correspond to the demand can be changed appropriately while ensuring the benefit that the organization 90 requires in accordance with the demand date (delivery date) in the demand conditions. In particular, even in a case in which a commodity or the like cannot be provided on the demand date (delivery date) in the demand conditions with the current resource information, it is possible to secure slots for allocating the necessary resources while ensuring the benefit that the organization 90 requires.

Further, as described above, the internal resource negotiation unit 150 and the external resource negotiation unit 160 generate new business deal conditions based on the conditions regarding a pattern in which the utility value exceeds the predetermined threshold. The internal resource negotiation unit 150 and the external resource negotiation unit 160 then determine whether or not new business deal conditions are met in accordance with the response information. Accordingly, it becomes possible to efficiently conduct negotiations for securing resources in such a way that the benefit for the organization 90 is secured. That is, according to the aforementioned configurations, it becomes possible to efficiently conduct negotiations while ensuring the benefit required for the own organization even in a case in which it is required to conduct negotiations among three parties including the customer, the own organization, and the supplier.

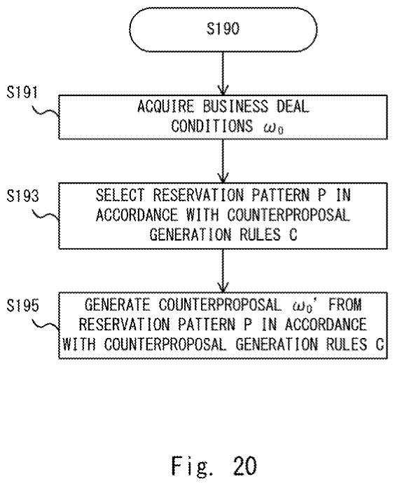

FIG. 20 is a flowchart showing details of the counterproposal generation processing (S190) shown in FIG. 5. The customer negotiation unit 120 acquires the business deal conditions ω₀ from the customer (Step S191). The customer negotiation unit 120 selects a reservation pattern P in accordance with predetermined counterproposal generation rules C (Step S193). Note that the counterproposal generation rules C may be those set in advance by the user. Alternatively, the counterproposal generation rules C may be a learned model learned by machine learning. Then, the customer negotiation unit 120 generates the counterproposal ω₀′ from the reservation pattern P selected in S193 in accordance with the counterproposal generation rules C (Step S195).

Now, an example of the counterproposal generation rules C in a case in which the commodity or the like cannot be provided by the delivery date in the business deal conditions ω₀ will be described. Regarding the processing of S193, the counterproposal generation rules C define that “one of the reservation patterns in which the shortest delivery date can be guaranteed is randomly selected as the reservation pattern P”. Further, regarding the processing of S195, the counterproposal generation rules C define that “for the reservation pattern P, a counterproposal ω₀′ in which a utility value r that exceeds the threshold t1 will likely to be obtained is generated. If there are a plurality of reservation patterns P, one of them is randomly selected”. In this case, if the customer accepts this counterproposal ω₀′, the benefit for the organization 90 can be ensured since the utility value r of the reservation pattern P exceeds the threshold t1.

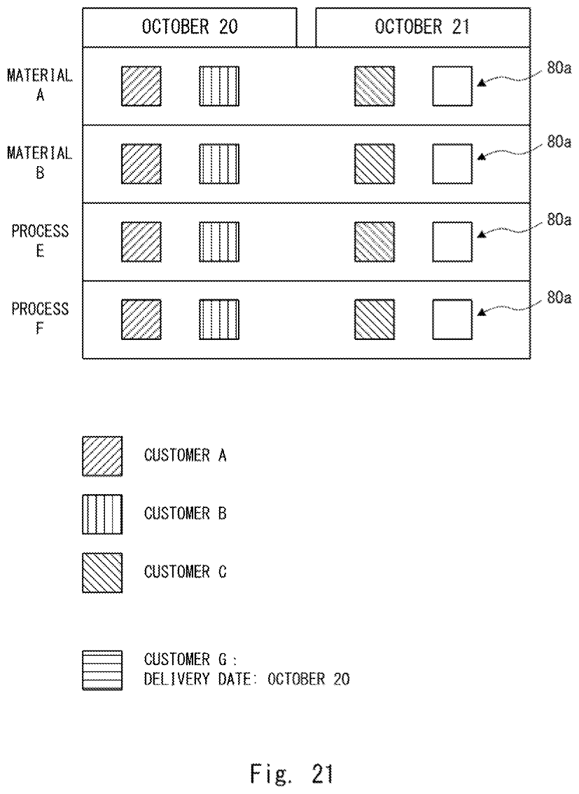

FIG. 21 is a diagram illustrating resource information in which the delivery date in the arrived business deal conditions cannot be satisfied. In the example shown in FIG. 21, resources that are required for commodities or the like according to business deals with a customer A and a customer B are allocated to the slots on October 20. Therefore, on October 20, all the slots have already been reserved for all the resources. Further, resources that are required for a commodity or the like according to a business deal with a customer C are allocated to the slots on October 21. Therefore, on October 21, for all the resources, one slot is an unoccupied slot (slot 80a). It is assumed that a business deal in which the delivery date is October 20 has arrived from a customer G.

In the case of the example shown in FIG. 21, the customer negotiation unit 120 determines that the shortest delivery date that can be guaranteed is “October 21”. Therefore, in the processing of S193, the customer negotiation unit 120 selects the reservation pattern P for allocating the resources according to the business deal with the customer G to unoccupied slots (the slots 80a) on October 21. Then, when the business deal conditions ω₀ include elements (e.g., price) other than the delivery date, the customer negotiation unit 120 sets the selling price in such a way that the selling price exceeds the price in the business deal conditions ω₀ in accordance with the counterproposal generation rules C that “it is expected that the utility value r that exceeds the threshold t1 will be obtained”. When, for example, it is expected to gain the benefit of 500,000 yen although the commodity can be provided for 1,500,000 yen from the attributes of the unoccupied slots, the selling price is decided to be 2,000,000 yen. In this case, a counterproposal ω₀′ (2,000,000 yen, October 21) is generated.

The aforementioned counterproposal generation rules C are merely examples and the counterproposal generation rules C are not limited to the aforementioned example. The counterproposal generation rules C in S193 may be, for example, “one of the reservation patterns that provide a resource that is similar to a resource causing the missed delivery date but can meet the delivery date is randomly selected as the reservation pattern P”. If, for example, the slot of the resource A becomes later than the delivery date for the business deal conditions regarding the commodity A and a resource A′ that is similar to the resource A is able to secure the slot before the delivery date arrives, the reservation pattern regarding the resource A′ may be selected. This case may include a case in which, for example, if the commodity A is an “automobile” and the resource A is a “leather seat”, the resource A′ is an “upholstered seat”. The determination regarding whether the resource A′ is similar to the resource A may be made by determining whether or not the similarity between the resource A′ and the resource A exceeds a predetermined threshold. Further, the counterproposal generation rules C in S193 may be “if a slot of a resource causing the missed delivery date is an ATP slot, one of the reservation patterns when the slot of the CTP that meets the delivery date is secured for the resource is randomly selected as the reservation pattern P”.

### Specific Examples

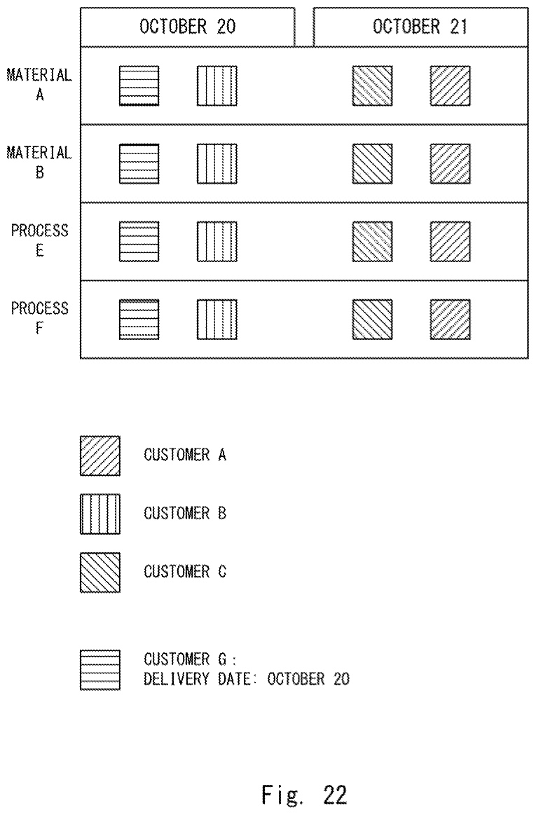

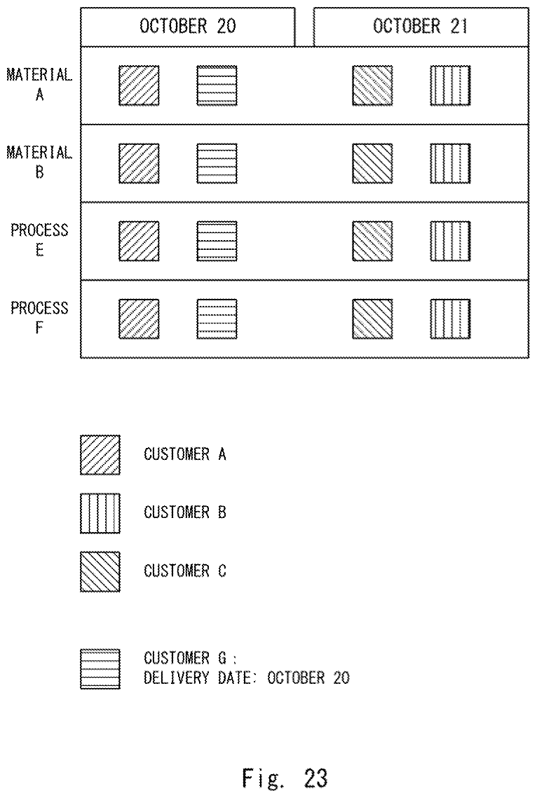

FIGS. 22 and 23 are diagrams for describing specific examples of the processing by the negotiation apparatus 100 according to the first example embodiment. Assume that the situation is like in the example in FIG. 21. In this case, the reallocation unit 130 generates a reallocation pattern #1 in which slots on October 20 to which the resources according to the customer A are allocated are switched with unoccupied slots 80a on October 21. Likewise, the reallocation unit 130 generates a reallocation pattern #2 in which slots on October 20 to which the resources according to the customer B are allocated are switched with unoccupied slots 80a on October 21 (S133).

Then, in the example shown in FIG. 22, the reallocation unit 130 determines that the utility value of the reallocation pattern #1 is larger than the utility value of the reallocation pattern #2 (YES in S137, S139). That is, F2 (reallocation pattern #1)>t2 and F2 (reallocation pattern #1)>F2 (reallocation pattern #2) are established. Therefore, the reallocation unit 130 selects the reallocation pattern #1 in which the slots on October 20 to which the resources according to the customer A are allocated are switched with the unoccupied slots 80a on October 21. Then, if the utility value exceeds the threshold with the reservation pattern according to the reallocation pattern #1 (YES in S145), the customer negotiation unit 120 decides to accept the business deal with the reservation pattern as shown in FIG. 22 (S148).

On the other hand, in the example shown in FIG. 23, the reallocation unit 130 determines that the utility value of the reallocation pattern #2 is larger than the utility value of the reallocation pattern #1 (YES in S137, S139). That is, F2 (reallocation pattern #2)>t2 and F2 (reallocation pattern #2)>F2 (reallocation pattern #1) are established. Therefore, the reallocation unit 130 selects the reallocation pattern #2 in which the slots on October 20 to which the resources according to the customer B are allocated are switched with the unoccupied slots 80a on October 21. Then, if the utility value exceeds the threshold with the reservation pattern according to this reallocation pattern #2 (YES in S145), the customer negotiation unit 120 determines that the business deal will be accepted with the reservation pattern as shown in FIG. 23 (S148).

In the negotiation method (FIG. 5) executed by the negotiation apparatus 100 according to the first example embodiment described above, the flow of the processing is not limited to the one shown in FIG. 5. For example, the negotiation apparatus 100 may execute the reallocation processing (S130) and the slot number change processing (S150) in parallel to each other. In this case, the negotiation operation decision unit 126 may compare the utility value of the reallocation pattern selected by the reallocation processing with the utility value of the slot number change pattern selected by the slot number change processing. In this case, when the utility value of the slot number change pattern exceeds a threshold and is larger than the utility value of the reallocation pattern, the negotiation operation decision unit 126 may decide the negotiation operation that corresponds to the slot number change pattern. Likewise, when there is an unoccupied slot in the processing of S104 in FIG. 5, the negotiation apparatus 100 may execute the processing of S110 and the processing of S130 in parallel to each other and thereby select a pattern having a high utility value. Further, when there is an unoccupied slot, the negotiation apparatus 100 may execute the processing of S110, the processing of S130, and the processing of S150 in parallel with one another, and thereby select the pattern having a high utility value.

### Second Example Embodiment

Next, a second example embodiment will be described. In the second example embodiment, the reallocation processing and the slot number change processing are executed before a business deal arrives. Since the configuration of a negotiation apparatus 100 according to the second example embodiment is substantially similar to that according to the first example embodiment, the descriptions thereof will be omitted.

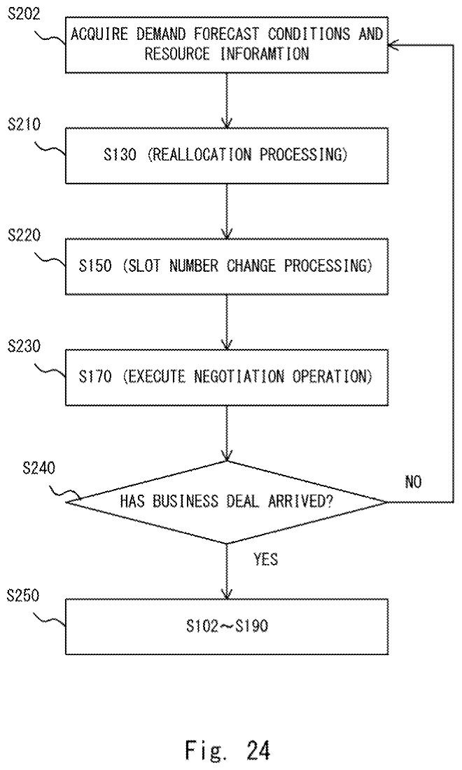

FIG. 24 is a flowchart showing a negotiation method executed by the negotiation apparatus 100 according to the second example embodiment. First, the negotiation apparatus 100 acquires demand forecast conditions and resource information (Step S202). Specifically, the condition acquisition unit 112 acquires demand forecast conditions, which are demand conditions. Further, the resource information acquisition unit 114 acquires resource information indicating the current availability status of the resources in the organization 90.

Next, the reallocation unit 130 executes reallocation processing, like in the processing of S130 (Step S210). Further, the slot number change unit 140 executes slot number change processing, like in the processing of S150 (Step S220). Further, at least one of the internal resource negotiation unit 150 and the external resource negotiation unit 160 executes the negotiation operation in accordance with the results of the processing of S220, like in the processing of S170 (Step S230). The processing of S210 and the processing of S220 and S230 may be performed in parallel to each other. Then, when a business deal has arrived (YES in Step S240), the processing from S102 to S190 is executed (Step S250). On the other hand, when the business deal has not arrived (NO in S240), the processing returns to S202.

As described above, in the second example embodiment, the reallocation unit 130 performs processing of selecting the pattern after the reallocation using demand forecast conditions before a business deal from the customer arrives. Likewise, in the second example embodiment, before the business deal from the customer arrives, the slot number change unit 140 performs, using the demand forecast conditions, processing of selecting the pattern after the number of slots has been changed. In this manner, the reallocation processing and the slot number change processing are executed before the business deal arrives, whereby the resource information may be changed to the one that corresponds to the demand forecast. In this case, the business deal may be concluded without performing the processing of S130, S150, and S170 in S250. Therefore, the negotiation apparatus 100 according to the second example embodiment is able to efficiently execute the processing when the actual business deal has arrived.

### Modified Examples

Note that the present invention is not limited to the aforementioned example embodiments and may be changed as appropriate within the scope of the present invention. For example, the order of the processing in the flowcharts shown in FIG. 5 and the like may be changed as appropriate. Further, one or more of the processing in the flowcharts shown in FIG. 5 and the like may be omitted. For example, in the flowchart shown in FIG. 4, the processing from S130 to S189 may be omitted. Further, for example, in the flowchart shown in FIG. 4, the processing from S150 to S189 may be omitted. Further, for example, in the flowchart shown in FIG. 4, the processing from S130 to S149 may be omitted. Further, the order of S170 and S180 may be reversed.

In the aforementioned examples, the program can be stored using any type of non-transitory computer readable medium and provided to the computer. The non-transitory computer readable media include various types of tangible storage media. Examples of the non-transitory computer readable medium include a magnetic storage medium (such as a flexible disk, a magnetic tape, and a hard disk drive), an optical magnetic storage medium (such as a magneto-optical disk), a CD-ROM (Read Only Memory), a CD-R, a CD-R/W, and a semiconductor memory (such as a mask ROM, a PROM (Programmable ROM), an EPROM (Erasable PROM), a flash ROM, and a RAM (Random Access Memory)). The program may be provided to a computer using various types of transitory computer readable media. Examples of the transitory computer readable medium include an electric signal, an optical signal, and an electromagnetic wave. The transitory computer readable medium can supply the program to a computer via a wired communication line, such as an electric wire and an optical fiber, or a wireless communication line.

While the present invention has been described above with reference to the example embodiments, the present invention is not limited by the aforementioned descriptions. Various changes that can be understood by one skilled in the art may be made within the scope of the invention to the configurations and the details of the present invention.

The whole or part of the above example embodiments can be described as, but not limited to, the following supplementary notes.

(Supplementary Note 1)

A negotiation apparatus comprising:

condition acquisition means for acquiring a demand condition including one or more elements regarding demand for a commodity or a service;

calculation means for calculating a utility value of the acquired demand condition using a predetermined utility function based on resource information indicating an availability status of one or more resources required to provide the commodity or the service; and

operation decision means for deciding a negotiation operation, which is an operation regarding a negotiation for providing the commodity or the service, based on the calculated utility value.

(Supplementary Note 2)

The negotiation apparatus according to Supplementary Note 1, wherein

the calculation means calculates the utility value for each of a plurality of feasible patterns in accordance with the resource information, and

the operation decision means decides the negotiation operation in accordance with the pattern in which the utility value exceeds a predetermined threshold.

(Supplementary Note 3)

The negotiation apparatus according to Supplementary Note 2, wherein the operation decision means decides the negotiation operation in accordance with the pattern in which the utility value becomes a maximum among the utility values that exceed the threshold.

(Supplementary Note 4)

The negotiation apparatus according to any one of Supplementary Notes 1 to 3, wherein

the demand condition includes a business deal condition regarding a business deal from a customer, and

the operation decision means decides whether or not to accept the business deal condition based on the utility value.

(Supplementary Note 5)

The negotiation apparatus according to Supplementary Note 4, wherein

the calculation means calculates, for each of a plurality of patterns configured in accordance with which one or more of a plurality of slots in the current availability status in the resource information one or more respective resources that are necessary for the business deal condition will be allocated to, the utility value of the business deal condition, and

the operation decision means decides to accept the business deal condition under a condition regarding the pattern in which the utility value exceeds a predetermined threshold.

(Supplementary Note 6)

The negotiation apparatus according to any one of Supplementary Notes 1 to 5, further comprising reallocation means for selecting, for each of a plurality of patterns configured by virtually performing reallocation of a slot that has already been allocated in the availability status of the resource information, a pattern after the reallocation based on the utility value of the demand condition calculated using a predetermined utility function.

(Supplementary Note 7)

The negotiation apparatus according to Supplementary Note 6, wherein

the demand condition includes a business deal condition regarding a business deal from a customer, and

the calculation means calculates, for each of a plurality of patterns configured in accordance with which one of a plurality of slots in the current availability status in the resource information one or more resources that are necessary for the business deal condition will be allocated to, the utility value of the business deal condition, and

when there is no pattern in which the utility value exceeds a predetermined threshold, the reallocation means performs an operation of selecting the pattern after the reallocation.

(Supplementary Note 8)

The negotiation apparatus according to Supplementary Note 7, wherein

the calculation means calculates, for each of a plurality of patterns configured in accordance with which one of slots in the pattern after the reallocation selected by the reallocation means one or more resources that are necessary for the business deal condition will be allocated to, the utility value of the business deal condition, and

the operation decision means decides to accept the business deal condition under a condition regarding the pattern in which the utility value exceeds a predetermined threshold.

(Supplementary Note 9)

The negotiation apparatus according to any one of Supplementary Notes 1 to 8, further comprising slot number change means for selecting, for each of a plurality of patterns configured by virtually changing the number of slots for supplying each resource in the availability status of the resource information, a pattern after the number of slots has been changed, based on the utility value of the demand condition calculated using a predetermined utility function.

(Supplementary Note 10)

The negotiation apparatus according to Supplementary Note 9, wherein

the demand condition includes a business deal condition regarding a business deal from a customer,

the calculation means calculates, for each of a plurality of patterns configured in accordance with which one of a plurality of slots in the current availability status in the resource information one or more resources that are necessary for the business deal condition will be allocated to, a utility value of the business deal condition, and

when there is no pattern in which the utility value exceeds a predetermined threshold, the slot number change means performs an operation of selecting the pattern after the number of slots has been changed.

(Supplementary Note 11)

The negotiation apparatus according to Supplementary Note 9 or 10, wherein

the demand condition includes a business deal condition regarding a business deal from a customer, and

the calculation means calculates the utility value of the business deal condition for each of a plurality of patterns configured in accordance with which one of slots in the pattern after the number of slots has been changed selected by the slot number change means one or more resources that are necessary for the business deal condition will be allocated to, and

the operation decision means decides to accept the business deal condition under a condition regarding the pattern in which the utility value exceeds a predetermined threshold.

(Supplementary Note 12)

The negotiation apparatus according to any one of Supplementary Notes 9 to 11, further comprising resource negotiation means for generating, based on the condition regarding the pattern in which the utility value exceeds a predetermined threshold, a new business deal condition regarding a new business deal regarding a resource allocated to the slot that has been changed in accordance with a change in the number of slots, and determining whether or not the new business deal condition is met in accordance with response information indicating a response to the business deal condition regarding the resource allocated to the slot that has been changed, the response information being generated by another negotiation apparatus in accordance with the generated business deal condition.

(Supplementary Note 13)

The negotiation apparatus according to Supplementary Note 6, wherein the reallocation means performs processing of selecting a pattern after the reallocation using a demand forecast condition, which is the demand condition, before a business deal from the customer arrives.

(Supplementary Note 14)

The negotiation apparatus according to Supplementary Note 9, wherein the slot number change means performs processing of selecting the pattern after the number of slots has been changed, using a demand forecast condition, which is the demand condition, before a business deal from the customer arrives.

(Supplementary Note 15)

A negotiation method comprising:

acquiring a demand condition including one or more elements regarding demand for a commodity or a service;

calculating a utility value of the acquired demand condition using a predetermined utility function based on resource information indicating an availability status of one or more resources required to provide the commodity or the service; and

deciding a negotiation operation, which is an operation regarding a negotiation for providing the commodity or the service, based on the calculated utility value.

(Supplementary Note 16)

The negotiation method according to Supplementary Note 15, comprising:

calculating the utility value for each of a plurality of feasible patterns in accordance with the resource information; and

deciding the negotiation operation in accordance with the pattern in which the utility value exceeds a predetermined threshold.

(Supplementary Note 17)

The negotiation method according to Supplementary Note 16, comprising deciding the negotiation operation in accordance with the pattern in which the utility value becomes a maximum among the utility values that exceed the threshold.

(Supplementary Note 18)

The negotiation method according to any one of Supplementary Notes 15 to 17, wherein

the demand condition includes a business deal condition regarding a business deal from a customer, and

the negotiation method comprises deciding whether or not to accept the business deal condition based on the utility value.

(Supplementary Note 19)

The negotiation method according to Supplementary Note 18, comprising:

calculating, for each of a plurality of patterns configured in accordance with which one or more of a plurality of slots in the current availability status in the resource information one or more respective resources that are necessary for the business deal condition will be allocated to, the utility value of the business deal condition, and

deciding to accept the business deal condition under a condition regarding the pattern in which the utility value exceeds a predetermined threshold.

(Supplementary Note 20)

The negotiation method according to any one of Supplementary Notes 15 to 19, comprising selecting, for each of a plurality of patterns configured by virtually performing reallocation of a slot that has already been allocated in the availability status of the resource information, a pattern after the reallocation based on the utility value of the demand condition calculated using a predetermined utility function.

(Supplementary Note 21)

The negotiation method according to Supplementary Note 20, wherein

the demand condition includes a business deal condition regarding a business deal from a customer, and

the negotiation method comprises calculating, for each of a plurality of patterns configured in accordance with which one of a plurality of slots in the current availability status in the resource information one or more resources that are necessary for the business deal condition will be allocated to, the utility value of the business deal condition, and

when there is no pattern in which the utility value exceeds a predetermined threshold, an operation of selecting the pattern after the reallocation is performed.

(Supplementary Note 22)

The negotiation method according to Supplementary Note 21, comprising:

calculating, for each of a plurality of patterns configured in accordance with which one of slots in the pattern after the reallocation that has been selected one or more resources that are necessary for the business deal condition will be allocated to, the utility value of the business deal condition, and

deciding to accept the business deal condition under a condition regarding the pattern in which the utility value exceeds a predetermined threshold.

(Supplementary Note 23)

The negotiation method according to any one of Supplementary Notes 15 to 22, comprising selecting, for each of a plurality of patterns configured by virtually changing the number of slots for supplying each resource in the availability status of the resource information, a pattern after the number of slots has been changed, based on the utility value of the demand condition calculated using a predetermined utility function.

(Supplementary Note 24)

The negotiation method according to Supplementary Note 23, wherein

the demand condition includes a business deal condition regarding a business deal from a customer,

the negotiation method comprises calculating, for each of a plurality of patterns configured in accordance with which one of a plurality of slots in the current availability status in the resource information one or more resources that are necessary for the business deal condition will be allocated to, a utility value of the business deal condition, and

the negotiation method comprises performing, when there is no pattern in which the utility value exceeds a predetermined threshold, an operation of selecting the pattern after the number of slots has been changed.

(Supplementary Note 25)

The negotiation method according to Supplementary Note 23 or 24, wherein

the demand condition includes a business deal condition regarding a business deal from a customer, and

the negotiation method comprises calculating the utility value of the business deal condition for each of a plurality of patterns configured in accordance with which one of slots in the pattern after the number of slots has been changed that has been selected one or more resources that are necessary for the business deal condition will be allocated to, and

the negotiation method comprises deciding to accept the business deal condition under a condition regarding the pattern in which the utility value exceeds a predetermined threshold.

(Supplementary Note 26)

The negotiation method according to any one of Supplementary Notes 23 to 25, comprising generating, based on the condition regarding the pattern in which the utility value exceeds a predetermined threshold, a new business deal condition regarding a new business deal regarding a resource allocated to the slot that has been changed in accordance with a change in the number of slots, and determining whether or not the new business deal condition is met in accordance with response information indicating a response to the business deal condition regarding the resource allocated to the slot that has been changed, the response information being generated by another negotiation apparatus in accordance with the generated business deal condition.

(Supplementary Note 27)

The negotiation method according to Supplementary Note 20, comprising performing processing of selecting a pattern after the reallocation using a demand forecast condition, which is the demand condition, before a business deal from the customer arrives.

(Supplementary Note 28)

The negotiation method according to Supplementary Note 23, comprising performing processing of selecting, using a demand forecast condition, which is the demand condition, the pattern after the number of slots has been changed, before a business deal from the customer arrives.

(Supplementary Note 29)

A non-transitory computer readable medium storing a program for causing a computer to execute the following steps of:

acquiring a demand condition including one or more elements regarding demand for a commodity or a service;

calculating a utility value of the acquired demand condition using a predetermined utility function based on resource information indicating an availability status of one or more resources required to provide the commodity or the service; and

deciding a negotiation operation, which is an operation regarding a negotiation for providing the commodity or the service, based on the calculated utility value.

### REFERENCE SIGNS LIST

1 Negotiation Apparatus
2 Condition Acquisition Unit
4 Calculation Unit
6 Operation Decision Unit
20 Negotiation System
80 Slot
90 Organization
100 Negotiation Apparatus
112 Condition Acquisition Unit
114 Resource Information Acquisition Unit
120 Customer Negotiation Unit
122 Pattern Generation Unit
124 Utility Value Calculation Unit
126 Negotiation Operation Decision Unit
130 Reallocation Unit
140 Slot Number Change Unit
150 Internal Resource Negotiation Unit
160 External Resource Negotiation Unit

What is claimed is:

1. A negotiation apparatus comprising:
hardware, including a processor and memory;
condition acquisition unit implemented at least by the hardware and configured to acquire a demand condition including one or more elements regarding demand for a commodity or a service;
calculation unit implemented at least by the hardware and configured to calculate a utility value of the acquired demand condition using a predetermined utility function based on resource information indicating an availability status of one or more resources required to provide the commodity or the service; and
operation decision unit implemented at least by the hardware and configured to decide a negotiation operation, which is an operation regarding a negotiation for providing the commodity or the service, based on the calculated utility value.

2. The negotiation apparatus according to claim 1, wherein
the calculation unit calculates the utility value for each of a plurality of feasible patterns in accordance with the resource information, and
the operation decision unit decides the negotiation operation in accordance with the pattern in which the utility value exceeds a predetermined threshold.

3. The negotiation apparatus according to claim 2, wherein the operation decision unit decides the negotiation operation in accordance with the pattern in which the utility value becomes a maximum among the utility values that exceed the threshold.

4. The negotiation apparatus according to claim 1, wherein
the demand condition includes a business deal condition regarding a business deal from a customer, and
the operation decision unit decides whether or not to accept the business deal condition based on the utility value.

5. The negotiation apparatus according to claim 4, wherein
the calculation unit calculates, for each of a plurality of patterns configured in accordance with which one or more of a plurality of slots in the current availability status in the resource information one or more respective resources that are necessary for the business deal condition will be allocated to, the utility value of the business deal condition, and
the operation decision unit decides to accept the business deal condition under a condition regarding the pattern in which the utility value exceeds a predetermined threshold.

6. The negotiation apparatus according to claim 1, further comprising reallocation unit implemented at least by the hardware and configured to select, for each of a plurality of patterns configured by virtually performing reallocation of a slot that has already been allocated in the availability status of the resource information, a pattern after the reallocation based on the utility value of the demand condition calculated using a predetermined utility function.

7. The negotiation apparatus according to claim 6, wherein
the demand condition includes a business deal condition regarding a business deal from a customer, and
the calculation unit calculates, for each of a plurality of patterns configured in accordance with which one of a plurality of slots in the current availability status in the resource information one or more resources that are necessary for the business deal condition will be allocated to, the utility value of the business deal condition, and
when there is no pattern in which the utility value exceeds a predetermined threshold, the reallocation unit performs an operation of selecting the pattern after the reallocation.

8. The negotiation apparatus according to claim 7, wherein
the calculation unit calculates, for each of a plurality of patterns configured in accordance with which one of slots in the pattern after the reallocation selected by the reallocation unit one or more resources that are necessary for the business deal condition will be allocated to, the utility value of the business deal condition, and
the operation decision unit decides to accept the business deal condition under a condition regarding the pattern in which the utility value exceeds a predetermined threshold.

9. The negotiation apparatus according to claim 1, further comprising slot number change unit implemented at least by the hardware and configured to select, for each of a plurality of patterns configured by virtually changing the number of slots for supplying each resource in the availability status of the resource information, a pattern after the number of slots has been changed, based on the utility value of the demand condition calculated using a predetermined utility function.

10. The negotiation apparatus according to claim 9, wherein
the demand condition includes a business deal condition regarding a business deal from a customer,
the calculation unit calculates, for each of a plurality of patterns configured in accordance with which one of a plurality of slots in the current availability status in the resource information one or more resources that are necessary for the business deal condition will be allocated to, a utility value of the business deal condition, and
when there is no pattern in which the utility value exceeds a predetermined threshold, the slot number change unit performs an operation of selecting the pattern after the number of slots has been changed.

11. The negotiation apparatus according to claim 9 or 10, wherein
the demand condition includes a business deal condition regarding a business deal from a customer, and
the calculation unit calculates the utility value of the business deal condition for each of a plurality of patterns configured in accordance with which one of slots in the pattern after the number of slots has been changed selected by the slot number change unit one or more resources that are necessary for the business deal condition will be allocated to, and
the operation decision unit decides to accept the business deal condition under a condition regarding the pattern in which the utility value exceeds a predetermined threshold.

12. The negotiation apparatus according to claim 9, further comprising resource negotiation unit implemented at least by the hardware and configured to generate, based on the condition regarding the pattern in which the utility value exceeds a predetermined threshold, a new business deal condition regarding a new business deal regarding a resource allocated to the slot that has been changed in accordance with a change in the number of slots, and determining whether or not the new business deal condition is met in accordance with response information indicating a response to the business deal condition regarding the resource allocated to the slot that has been changed, the response information being generated by another negotiation apparatus in accordance with the generated business deal condition.

13. The negotiation apparatus according to claim 6, wherein the reallocation unit performs processing of selecting a pattern after the reallocation using a demand forecast condition, which is the demand condition, before a business deal from the customer arrives.

14. The negotiation apparatus according to claim 9, wherein the slot number change unit performs processing of selecting the pattern after the number of slots has been changed, using a demand forecast condition, which is the demand condition, before a business deal from the customer arrives.

15. A negotiation method comprising:
acquiring a demand condition including one or more elements regarding demand for a commodity or a service;
calculating a utility value of the acquired demand condition using a predetermined utility function based on resource information indicating an availability status of one or more resources required to provide the commodity or the service; and
deciding a negotiation operation, which is an operation regarding a negotiation for providing the commodity or the service, based on the calculated utility value.

16. The negotiation method according to claim 15, comprising:
calculating the utility value for each of a plurality of feasible patterns in accordance with the resource information; and
deciding the negotiation operation in accordance with the pattern in which the utility value exceeds a predetermined threshold.

17. The negotiation method according to claim 16, comprising deciding the negotiation operation in accordance with the pattern in which the utility value becomes a maximum among the utility values that exceed the threshold.

18. The negotiation method according to claim 15, wherein
the demand condition includes a business deal condition regarding a business deal from a customer, and
the negotiation method comprises deciding whether or not to accept the business deal condition based on the utility value.

19. The negotiation method according to claim 18, comprising:
calculating, for each of a plurality of patterns configured in accordance with which one or more of a plurality of slots in the current availability status in the resource information one or more respective resources that are necessary for the business deal condition will be allocated to, the utility value of the business deal condition, and
deciding to accept the business deal condition under a condition regarding the pattern in which the utility value exceeds a predetermined threshold.

20-28. (canceled)

29. A non-transitory computer readable medium storing a program for causing a computer to execute the following steps of:
acquiring a demand condition including one or more elements regarding demand for a commodity or a service;
calculating a utility value of the acquired demand condition using a predetermined utility function based on resource information indicating an availability status of one or more resources required to provide the commodity or the service; and
deciding a negotiation operation, which is an operation regarding a negotiation for providing the commodity or the service, based on the calculated utility value.
